(19) United States
(12) Patent Application Publication
(10) Pub. No.: US 2011/0071721 A1
(43) Pub. Date: Mar. 24, 2011

(54) SYSTEMS AND METHODS FOR OBTAINING EMISSIONS OFFSET CREDITS

(76) Inventors: Graham B. Gilfillan, Kamloops (CA); Douglas A. Kops, Kamloops (CA); Gary H. Van Ryssel, Maple Ridge (CA); Robert C. Hodgins, Brampton (CA); Steve K. Eagan, Hampstead, MD (US); Joseph A. Doty, Baldwin Park, CA (US); John A. Doherty, Louisville, CO (US); Suzanna M. Doherty, Louisville, CO (US); Allan Van Ryssel, Maple Ridge (CA)

(21) Appl. No.: 12/920,571

(22) PCT Filed: Mar. 2, 2009
(86) PCT No.: PCT/US09/35775

§ 371 Date: Nov. 27, 2010

Related U.S. Application Data
(60) Provisional application No. 61/032,968, filed on Mar. 1, 2008.

(51) Int. Cl. G06Q 99/00; G06Q 90/00; G06F 7/00

(52) U.S. Cl. 701/30; 705/500; 705/1.1

(57) ABSTRACT

Methods for obtaining emissions offset credits and methods for reducing emissions from a fuel filler cap. An interface system for gathering emissions reduction data and for converting the emissions reduction data into emissions trading data includes at least one tester for generating the emissions reduction data, at least one local computer for gathering the emissions reduction data from the at least one tester, and a central computer for converting the emissions reduction data gathered by the at least one local computer into the emissions trading data.

### CROSS-REFERENCE TO RELATED APPLICATIONS

This application claims benefit of priority to U.S. Provisional Patent Application Ser. No. 61/032,968, filed Mar. 1, 2008, which is incorporated herein by reference.

### BACKGROUND

Modern society generates large amounts of undesired emissions that harm human health and/or the environment. For example, vehicles and electric power plants collectively generate large amounts of undesired emissions such as carbon dioxide, methane, nitrous oxide, sulfur hexafluoride, benzene, and volatile organic compounds such as hydrocarbons, which include but are not limited to, hydrofluorocarbons and perfluorocarbons. As another example, hazardous liquid wastes, such as used engine coolant and motor oil, are produced in large quantities and present a waste disposal problem.

In many instances, the costs associated with reducing emissions discourage making such reductions. For example, absent government regulations, a power plant owner may elect to not install scrubbing equipment to reduce the plant's emissions due to the equipment's high cost. As another example, although a vehicle's owner may desire to reduce emissions resulting from a defective component on the vehicle, the owner may not be able to afford the costs associated with replacing the component. Accordingly, many opportunities to reduce emissions are missed due to the lack of economic incentive to make such reductions.

### Emissions Trading Systems

It is known to use an emissions trading system to encourage emissions reductions in a manner that presents among the lowest overall costs to society. An authority, such as a governmental authority or a private entity, sets a maximum limit or cap on the total amount of one or more emissions types that may be collectively generated in a given area by all emitters subject to the cap.

The authority issues allowances or credits equal to the cap. Credits allow a holder to emit emissions up to the amount of credits that they hold. Each emitter subject to the cap must hold at least enough credits to cover the maximum amount of emissions that it produces over an allowed amount. In some situations, the allowed amount may be zero.

Markets permitting free trade of credits among emitters and speculators may be provided for the emissions trading systems. Market allocation helps distribute credits to the emitters that value the credits most, which in turn helps achieve emission reductions at an overall lowest cost to society. The markets effectively assign a monetary value to the credits through trading. Credits may be exchanged at prevailing market prices. An emitter that needs to increase its emissions will need to purchase additional credits to offset the increase. Conversely, a party that has excess credits can sell them.

The Kyoto Protocol is an international agreement that sets binding targets for reducing greenhouse gas (GHG) emissions. Participating countries voluntarily agree to comply with an emissions trading system for the following six greenhouse gases: carbon dioxide, methane, nitrous oxide, sulfur hexafluoride, hydrocarbons, and perfluorocarbons. Under the Treaty, countries must meet their targets primarily through national measures. However, the Kyoto Protocol offers them an additional market-based means of meeting their targets. Each participating country agrees to respective emission caps, and during a five year compliance period, a country that emits less than its cap will be able to sell emission credits to countries that exceed their cap.

The Chicago Climate Exchange (CCX) is an example of an emissions trading system. The CCX is a voluntary exchange where members contract to reduce emissions of the six greenhouse gases regulated under the Kyoto protocol. Specifically, CCX members contract to meet annual greenhouse gas reduction targets. Members that reduce their emissions below their target levels earn emission credits or allowances, and members who produce emissions in excess of their targets buy allowances from other CCX members. The CCX also includes offset projects. The CCX issues tradable contracts to owners of eligible projects on the basis of sequestration, destruction, or reduction of greenhouse gas emissions. Offset providers do not have significant GHG emissions.

Other examples of emissions trading systems include, but are not limited to, the European Union Emission Trading Scheme, the Montreal Climate Exchange, the Western Climate Initiative, the Regional Greenhouse Gas Initiative in northeast United States, and systems instituted in regional air quality districts.

Many emissions trading systems enable a party to earn, and subsequently sell or hold, credits by the sequestration, destruction, or reduction of emissions, such as greenhouse gase emissions. Such sequestration, destruction, or reduction achieves an emissions reduction that would not have occurred but for the party's actions. Such earned emissions credits are sometimes referred to as emission reduction credits, emission reduction offsets, or carbon offset credits. For example, the CCX may issue contracts from qualifying greenhouse gas sequestration, destruction, or reduction projects that are not part of a cap and trade system. The amount of a greenhouse gas sequestered, destroyed, or reduced is commonly represented for trading purposes by its carbon dioxide equivalent (CO₂e), where the carbon dioxide equivalent corresponds to an amount of carbon dioxide having the same global warming potential as the greenhouse gas.

The specific requirements to earn emissions offset credits may vary among emissions trading systems. The following is one example of specific requirements that must be met in order for a party to earn emissions offset credits. First, the party must show that the emissions reduction is surplus—that is the emissions reduction must be in addition to any reduction that would otherwise be obtained. Such requirement is sometimes referred to as the “additionality” requirement. Additionality is sometimes shown by demonstrating that the party's emissions reduction action would not occur without the availability of emission offset credits.

Second, the party must quantify the emissions reduction and have such reduction verified, such as by an independent third party. Third, the party must show that the emissions reduction is “real”—this is, the emissions reduction is not offset by an emissions increase elsewhere. Fourth, the party must show the emissions reduction to be permanent, that is sustained for a specified time period.

### Fuel Filler Caps

Fuel tanks are extremely pervasive in modern society. For example, most automobiles include a fuel tank for storing a liquid fuel, such as gasoline, diesel fuel, and liquefied petroleum, used to fuel the automobile. Fuel tanks are also widely found, for example, on motorcycles and on airplanes, as well as in gardening, maintenance, and construction equipment such as lawn mowers, edgers, snow blowers, air compressors, and portable generators. Furthermore, fuel tanks are commonly found on recreation equipment such as snowmobiles, all terrain vehicles, boats, jet skis, dune buggies, etc. Moreover, fuel tanks are sometimes stand alone portable fuel containers that are used to transport fuel from a fuel point to a device or tank disposed elsewhere—one example of a portable fuel container is a portable “fuel can” used to fill fuel tanks on equipment such as lawn mowers, snow blowers, etc.

Fuel tanks are generally designed to be replenished when their stored fuel level is low. For example, a vehicle's fuel tank must be periodically replenished because the vehicle consumes fuel from the tank as the vehicle operates. Accordingly, many fuel tanks include an opening, sometimes referred to as a fuel filler neck, to allow fuel to be added to the tank.

It is desirable to seal the fuel filler neck when it is not being used to add fuel to the fuel tank. One reason to seal the fuel filler neck is to keep contaminants, such as dirt and water, from entering the fuel tank. Another reason to seal the fuel filler neck is to prevent fuel and fuel vapors, such as from gasoline or diesel fuel, from escaping from the fuel tank. Not only do escaping fuel vapors constitute undesired emissions, evaporation of fuel also results in waste of the fuel.

A fuel filler cap is used to seal a fuel filler neck when it is not in use. The cap includes a seal to seal the opening of the fuel filler neck, and the cap frequently additionally includes one or more vents to help maintain a desired pressure within the fuel tank. One example of a fuel filler cap is a gas cap used to seal the fuel filler neck of a gasoline storage tank. Unfortunately, the fuel filler cap's seal and/or vents commonly degrade over time and eventually no longer provide a tight seal, thereby allowing fuel vapors to escape from the fuel tank. Additionally, a fuel filler cap may leak because it is not properly installed, such as not adequately tightened. Furthermore, a fuel filler cap may be completely missing from the fuel filler neck due to the user misplacing the cap.

### Engine Oil

Many engines include a lubrication system that uses motor oil to lubricate the engine. The lubrication system commonly includes an oil filter to remove contaminants from the system's motor oil. Nevertheless, even with the oil filter's presence, the motor oil eventually becomes sufficiently contaminated such that it is no longer suitable for lubricating the engine. In particular, engine damage can result from operating the engine with contaminated oil. Furthermore, motor oil additives designed to protect the engine and/or increase engine performance may also degrade over time to the point that they are ineffective. Accordingly, motor oil generally must be replaced or “changed” from time to time.

### Engine Coolant

An engine produces heat as it operates. This waste heat must be removed from the engine, or engine damage will result. Some engines are “air cooled”—that is, the engine is cooled by directing air across heat exchanging surfaces of the engine, and heat is transferred from the engine to the air. However, many engines are “water cooled” where a cooling system circulates a liquid, commonly referred to as coolant, along heat exchanging surfaces of the engine. Heat is transferred from the engine to the coolant, and the coolant is subsequently cooled, such as by transferring heat from the coolant to the environment using a radiator.

Engine coolant commonly consists of water and antifreeze. As its name implies, antifreeze helps prevent coolant from freezing. But, antifreeze may perform other useful functions. For example, antifreeze may raise the coolant's boiling point and may include additives to help minimize cooling system wear (e.g., help reduce rust and corrosion).

Engine coolant eventually becomes contaminated such that it no longer serves its intended purpose. For example, coolant may become contaminated with rust, scale, metals, and sludge. Accordingly, engine coolant generally must be replaced from time to time.

### SUMMARY

In an embodiment, a method for reducing emissions from a fuel filler cap includes valuating a cost of replacing the fuel filler cap, calculating an amount of emissions that corresponds to an emissions offset credit having a monetary value equal to the cost, estimating an emissions threshold that an object having a fuel container would have to reach to meet the amount of emissions, measuring a leakage amount of the fuel filler cap, and replacing the fuel filler cap when the measured leakage amount exceeds the emissions threshold.

In an embodiment, a method for obtaining emissions offset credits by testing a population of fuel tanks that includes instances of both leaking and non-leaking fuel filler caps includes testing each fuel filler cap for leakage. The fuel filler cap is determined to pass when the fuel filler cap's leakage is below a threshold amount. The fuel filler cap is determined to fail when the fuel filler cap's leakage is above the threshold amount. When the fuel filler cap fails, the fuel filler cap is replaced, and emissions offset credits are obtained for emissions reductions resulting from replacing the fuel filler cap.

In an embodiment, a method for obtaining emissions offset credits by testing a population of fuel tanks that includes instances of missing fuel filler caps includes checking whether each fuel filler neck of the population of fuel tanks has a missing fuel filler cap. When the fuel filler neck has a missing fuel filler cap, a replacement fuel filler cap is provided, and emissions offset credits are obtained for emissions reductions resulting from replacing the missing fuel filler cap.

In an embodiment, a method for obtaining carbon offset credits includes testing the integrity of a gas cap on a vehicle that is not subject to having its gas cap tested on a periodic basis, determining that the integrity of the gas cap is acceptable when the gas cap's leakage is below a threshold, determining that the integrity of the gas cap is unacceptable when the gas cap's leakage is above the threshold, replacing the gas cap when its integrity is unacceptable, and obtaining a carbon offset credit when the gas cap is replaced.

In an embodiment, a method for obtaining emissions offset credits by reducing use of motor oil includes the following steps: (1) upon a request to change motor oil of an engine, testing a condition of the motor oil; (2) determining whether the condition is acceptable; (3) changing the motor oil solely when the condition is unacceptable; and (4) when the condition is acceptable, obtaining emissions offset credits for emissions reductions resulting from not changing the motor oil.

In an embodiment, a method for obtaining emissions offset credits by reducing use of antifreeze includes the following steps: (1) upon a request to change coolant in an engine cooling system, testing a condition of the coolant; (2) determining whether the condition is acceptable; (3) changing the coolant solely when the condition is unacceptable; and (4) when the condition is acceptable, obtaining emissions offset credits for emissions reductions resulting from not changing the coolant.

In an embodiment, a method for obtaining emissions offset credits by reducing evaporation of fuel from a portable fuel container includes replacing a leak prone portable fuel container with a low leak portable fuel container, and obtaining emissions offset credits for emissions reductions resulting from preventing evaporation of fuel from the leak prone portable fuel container.

In an embodiment, a method for obtaining emissions offset credits includes repairing an engine emissions control system, and obtaining emissions offset credits for emissions reductions resulting from repairing the emissions control system.

In an embodiment, a method for obtaining emissions offset credits includes installing an electronic catalytic converter in series with a fuel intake line of an internal combustion engine, and obtaining emissions offset credits for emissions reductions resulting from installing the electronic catalytic converter.

In an embodiment, a method for obtaining emissions offset credits includes performing an activity selected from the group consisting of implementing an energy conservation measure and installing a renewable energy source, and obtaining emissions offset credits for emissions reductions resulting from performing the activity.

In an embodiment, an interface system for gathering emissions reduction data and for converting the emissions reduction data into emissions trading data includes at least one tester for generating the emissions reduction data, at least one local computer for gathering the emissions reduction data from the at least one tester, and a central computer for converting the emissions reduction data gathered by the at least one local computer into the emissions trading data.

In an embodiment, a computer program for obtaining emissions offset credits by testing a population of fuel tanks that includes instances of both leaking and non-leaking fuel filler caps is stored on a computer readable medium. The computer program includes instructions, which, when executed by a computer, perform the following steps: (1) testing each fuel filler cap for leakage; (2) determining that the fuel filler cap passes when the fuel filler cap's leakage is below a threshold amount; (3) determining that the fuel filler cap fails when the fuel filler cap's leakage is above the threshold amount; and (4) when the fuel filler cap fails, obtaining emissions offset credits for emissions reductions resulting from replacing the fuel filler cap.

In an embodiment, a method for obtaining emissions offset credits by replacing a leaking fuel filler cap of a vehicle includes testing the fuel filler cap for leakage. The fuel filler cap is replaced with a replacement fuel filler cap, and a difference in leakage between the fuel filler cap and the replacement fuel filler cap is calculated. An emissions reduction of the vehicle based on the difference in leakage is estimated, and emissions offset credits for the emissions reduction are applied for.

### BRIEF DESCRIPTION OF DRAWINGS

FIG. 1 shows one method of obtaining emissions offset credits by testing fuel filler caps of a population of fuel tanks that includes instances of both leaking and non-leaking fuel filler caps, according to an embodiment.

FIG. 2 shows one method of obtaining emissions offset credits by testing fuel filler caps of a population of fuel tanks that includes instances of both leaking and non-leaking fuel filler caps, according to an embodiment.

FIG. 3 shows one method of quantifying the reduction in hydrocarbon emissions achieved by executing the methods of FIG. 1 or 2, according to an embodiment.

FIG. 4 shows one method of quantifying the reduction in carbon dioxide emissions achieved by executing the methods of FIG. 1 or 2, according to an embodiment.

FIG. 5 shows one method of quantifying the fuel savings achieved by executing the methods of FIG. 1 or 2, according to an embodiment.

FIG. 6 shows one method of quantifying the reduction in greenhouse gas emissions achieved by executing the methods of FIG. 1 or 2, according to an embodiment.

FIG. 7 shows one method of obtaining emissions offset credits by reducing use of engine motor oil, according to an embodiment.

FIG. 8 shows one method of obtaining emissions offset credits by reducing use of antifreeze, according to an embodiment.

FIG. 9 shows one method of obtaining emissions offset credits by reducing evaporation of fuel from portable fuel containers, according to an embodiment.

FIG. 10 shows one method of obtaining emissions offset credits by repairing an engine's emission control system, according to an embodiment.

FIG. 11 shows one method of obtaining emissions offset credits by installing an electronic catalytic converter in series with the fuel intake line of an internal combustion engine, according to an embodiment.

FIG. 12 shows one method of obtaining emissions offset credits by implementing an energy conservation measure and/or by installing a renewable energy source, according to an embodiment.

FIG. 13 shows one interface system for gathering emissions reduction data and converting the data into emissions trading data, according to an embodiment.

FIG. 14 shows one interface system for gathering emissions reduction data and converting the data into emissions trading data, according to an embodiment.

### DETAILED DESCRIPTION OF THE EMBODIMENTS

It is noted that, for purposes of illustrative clarity, certain elements in the drawings may not be drawn to scale. Specific instances of an item may be referred to by use of a numeral in parentheses (e.g., tester 1402(1)) while numerals without parentheses refer to any such item (e.g., testers 1402).

As discussed above, many opportunities to reduce emissions are missed due to the lack of economic incentive to make such reductions. However, novel methods and systems discussed herein may advantageously reduce emissions and generate a corresponding monetary return, thereby potentially helping to overcome the lack of economic incentives to reduce emissions. For example, emissions reduction systems and/or processes may be made economically viable by obtaining emissions offset credits for emissions reductions achieved by implementing such systems and/or by executing such processes.

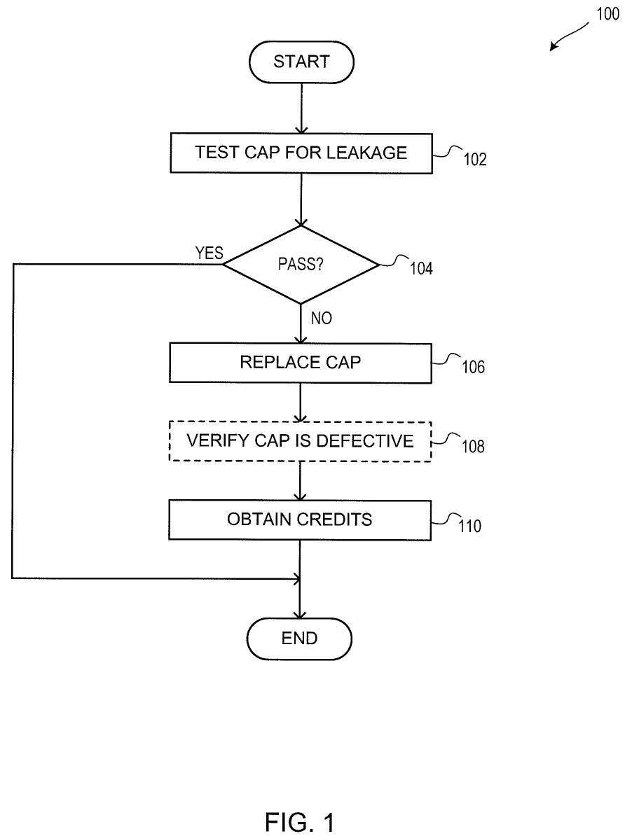

FIG. 1 shows one method 100 of obtaining emissions offset credits by testing fuel filler caps of a population of fuel tanks that includes instances of both leaking and non-leaking fuel filler caps. The population of fuel tanks includes, for example, fuel tanks of one or more of the following: vehicles such as cars, trucks, and motorcycles; airplanes; helicopters; watercraft such as boats and jet skis; construction equipment such as earth moving equipment, air compressors, and portable generators; gardening, maintenance, and landscaping equipment such as lawnmowers, edgers, snow blowers, and string trimmers; recreation equipment such as snow mobiles and dune buggies; fuel transport and storage equipment such as portable fuel containers; and any other object including a fuel tank.

In some embodiments of method 100, the population of fuel tanks is limited to fuel tanks that would likely not have their fuel filler caps tested but for execution of method 100. For example, method 100 may be used to test fuel filler caps of a population of vehicles that are operated in areas without mandatory physical testing of fuel filler caps for leakage. Method 100 may also be used, for example, to test fuel filler caps of some or all vehicles brought to a service center, such as a tire store, for maintenance or repairs unrelated to the vehicles' fuel filler caps, thereby resulting in testing of fuel filler caps that would likely not otherwise be physically tested. As yet another example, method 100 may be used to test the fuel filler caps of community members who voluntarily submit their fuel filler caps for leakage testing. Some embodiments of method 100 could also replace or supplement an existing and/or a proposed emissions inspection and maintenance program.

Method 100 begins with step 102 where a fuel filler cap from the population is tested for leakage. Stated differently, the fuel filler cap's integrity is tested in step 102. Step 102 includes, for example, testing the cap's seal and/or vents for leakage. It should be noted that in some embodiments of step 102, solely the fuel filler cap is tested for leakage. For example, in the case of a vehicle, the fuel filler cap, and not the vehicle's entire emissions control system, is tested for leaks in some embodiments of step 102.

Step 102 preferably includes removing the fuel filler cap from its respective fuel filler neck and testing the cap's leakage with an external test instrument. The external test instrument is, for example, certified by a governmental agency for testing fuel filler caps.

One example of step 102 is removing a fuel filler cap and testing it with a Waekon Corporation FPT2600E Handheld Fuel Cap Tester. The FPT2600E provides a pass/fail test result—if the cap's leakage is below a threshold amount, the cap passes; if the cap's leakage is above the threshold amount, the cap fails. The FPT2600E also indicates whether a passing cap is leaking, which means that the cap has a leakage of greater than zero, but less than the threshold amount.

Another example of step 102 is removing a fuel filler cap and testing it with a Waekon FPT27 Electronic Fuel Cap Tester. The FPT27 includes communication interfaces for communicating with an external subsystem, such as an Emission Inspection System (“EIS”) test center computer that uses the BAR-97 standard. The FPT27 is operable to send test data to an external computer which is connected thereto. The external computer, for example, executes software operable to process test data from the FPT27. In some embodiments of step 102, the FPT27 is wirelessly connected to a computer, and the FPT27 is operable to wireless transmit test data to the computer.

In some embodiments of step 102, the fuel filler cap is tested for leakage with the aid of diagnostic equipment residing on the equipment hosting the fuel filler cap. For example, a vehicle's fuel filler cap could be tested in step 102 with the help of the vehicle's on-board diagnostic equipment, such as OBD-I, OBD-II, or OBD-III on-board diagnostic equipment. A technician may access the on-board diagnostic equipment, such as by coupling a test instrument with the equipment, to obtain diagnostic data that may be useful in evaluating the fuel filler cap's integrity.

On-board diagnostic data may also be obtained for use in some embodiments of step 102 without a technician's assistance. For example, a vehicle's on-board diagnostic equipment may automatically transmit diagnostic data to an external system, such as a communications network, and a party executing one or more steps of method 100 directly or indirectly accesses the diagnostic data from the external system. This automatic transmission of diagnostic data occurs, for example, via radio-frequency, cellular, satellite, optical, or wi-fi communication.

Another example of accessing on-board diagnostic data for use in some embodiments of step 102 is monitoring a vehicle's on-board diagnostic equipment via a data logger. The data logger, which is coupled with the vehicle's on-board diagnostic equipment, records on-board diagnostic data. A party executing one or more steps of method 100 subsequently accesses the diagnostic data from the data logger. In some embodiments, the data logger is removably coupled to the vehicle's on-board diagnostic equipment, such as via an electrical connector, and the data logger is periodically decoupled for accessing diagnostic data stored therein.

Yet another example of accessing on-board diagnostic data is a vehicle owner driving an on-board diagnostic equipment equipped vehicle to a self service test kiosk. The vehicle's on-board diagnostic equipment is coupled with the kiosk, such as via a cable or wireless communication, and diagnostic data is transmitted from the on-board diagnostic equipment to the kiosk. A party implementing one or more steps of method 100 directly or indirectly obtains the diagnostic data from the kiosk.

If on-board diagnostic equipment indicates a problem (e.g., an emissions control system problem) in embodiments of step 102 utilizing on-board diagnostic data, the fuel filler cap can then be directly or indirectly tested to determine whether the cap is the source of the problem. For example, the fuel filler cap can be indirectly tested by replacing it on the fuel filler neck with a known non-leaking cap to determine whether the fuel filler cap is the source of the leak. However, an external test instrument may provide more accurate test results than on-board diagnostic equipment, and such increased accuracy may result in obtaining more emissions offset credits. For example, an external test instrument may be able to detect a leak as small as 60 cubic centimeters, while on-board diagnostic equipment may not be able to detect a leak smaller than 600 cubic centimeters. Furthermore, an external test instrument may provide leakage information that is specific to the fuel filler cap, while on-board diagnostic equipment may only be able to provide system level leakage information, such as whether there is a leak somewhere in an emissions control system.

In decision step 104, the test results of step 102 are considered to determine whether the fuel filler cap passes or fails. A cap with an acceptable leakage is considered to pass, and a cap with an unacceptable leakage is considered to fail. An example of step 104 is comparing numerical leakage values obtained in step 102, which represent seal and/or vent leakage, to a threshold amount, such as a predetermined measure of vapor effluent. The cap is deemed to pass if the leakage value is below the threshold. Conversely, the cap is deemed to fail if the leakage value is above the threshold. The threshold amount may be a regulated threshold specified by a regulating entity, such as a governmental entity. For example, the regulated threshold may be 60 cubic centimeters. As another example, if the test of step 102 merely provides a pass/fail result (as opposed to a numerical leakage value), such result is adopted in step 104 as the decision on whether the cap passes or fails.

As yet another example of step 104, if a Waekon FPT27 Electronic Fuel Cap Tester connected to a computer is used in step 102 to test a fuel filler cap, the FPT27 may transfer test data to the computer which electronically records the test data. The computer compares the test data to the threshold amount to determine whether the cap passes. The computer may further be operable to generate reports showing test statistics such as how many caps have been tested, how many caps have passed, how many caps have failed, etc.

If the cap passes in decision step 104, method 100 ends. Otherwise, method 100 proceeds from decision step 104 to step 106. The results of step 104 may be recorded, such as in a computer system, and/or on paper.

In step 106, the failing fuel filler cap is replaced with a passing cap, such as a new cap or a reconditioned cap. In some embodiments, the failing cap is replaced with a passing cap on the spot. The passing cap is, for example, a cap certified for use as a replacement fuel filler cap and may be a zero leak fuel filler cap. In the context of this patent application and corresponding claims, a zero leak fuel filler cap has negligible leakage. The replacement cap may also be a “touchless” cap, which allows for refueling without removing the cap. Utilizing a touchless replacement cap may advantageously allow earning of additional offset credits due to a user not having to remove and reinstall the cap on a regular basis, which reduces the likelihood that the cap will be incorrectly installed and thereby leak.

In some embodiments, the replacement cap is certified to have an acceptable integrity for a long period of time, such as in the case of a vehicle, the lesser of 15 years or 150,000 miles, thereby enabling earning of additional emissions offset credits. The passing cap may even have a lifetime warranty, which may enable earning of yet additional emissions offset credits. The passing cap is optionally secured to the equipment hosting the fuel tank, or the fuel tank itself, with a tether to prevent loss of the fuel filler cap. For example, a vehicle's fuel filler cap may be secured to the vehicle using a tether. The failing fuel filler cap may be retained, such as for a year, for auditing purposes. The failing fuel filler cap may also be recycled after it is no longer needed for auditing and/or verification purposes. Additional emissions offset credits for emissions reductions resulting from recycling the cap may be obtained.

In alternative embodiments of step 106, a community member is provided an economic incentive to replace the failing cap with a passing cap. An example of such economic incentive is providing the community member a voucher enabling the member to obtain a passing cap at a reduced price or at no cost.

In optional step 108, the fact that the fuel filler cap fails is verified. Such verification may be required to obtain emissions offset credits and may need to be performed by a party unrelated to the party (or parties) executing the remainder of method 100 to ensure the verification is considered unbiased. Additionally, the optional retesting in step 108 may be useful in confirming the accuracy of the testing of step 102. One example of performing step 108 is to send the failing fuel filler caps to a third party verifier. The third party verifier in turn, re-tests the failing fuel filler cap to determine whether its leakage value is above the threshold value. The third party's test results may optionally be adjusted to compensate for resetting of defective vents during the shipment of the failing fuel filler caps to the third party verifier. Such adjustment may be desirable because shipment of failing caps may subject the caps to rough handling, and the rough handling may temporarily reset failed vents and cause erroneous verification results, such as a false determination that a failing fuel filler cap is passing. In some embodiments of method 100 where a plurality of fuel filler caps are tested, only a subset of the failing fuel filler caps are sent to the third party verifier. For example, one percent of failing fuel filler caps may be sent to the third party verifier. As another example, some portion of failing fuel filler caps may be sent to the third party verifier in the early stages of execution of method 100, and such verification may be reduced or eliminated after confidence in the testing of method 100 is established.

In addition to or as an alternate to sending a failing fuel filler cap to a third party verifier, a failing fuel filler cap can be re-tested in optional step 108, such as at the same location where step 102 is performed. For example, if method 100 is performed on vehicles brought to an automotive service facility, a cap determined to fail in step 104 can be retested at the automotive service facility, such as by using a different test instrument than was used in step 102. Furthermore, the identification of the apparatus hosting the failing fuel filler cap may be manually or automatically recorded, such as by a computer connected to an external test instrument. For example, if the failing fuel filler cap is from a vehicle, the vehicle's identification number may be recorded.

In step 110, emissions offset credits are obtained for replacing the failing fuel filler cap in step 106. Such credits may be used, for example, to make method 100 economically feasible. Examples of the offset credits include hydrocarbon emissions offset credits, carbon dioxide emissions offset credits, or carbon dioxide equivalent emissions offset credits.

The offset credits may correspond to the emissions reductions achieved by replacing the failing cap with a passing cap. Such emissions reductions may include direct and/or indirect emissions reductions. One example of indirect emissions reductions are reductions achieved by preventing emissions generation during the “fuel cycle”. The fuel cycle represents energy required to provide a unit of fuel to the end user, accounting for activites such as exploring, drilling, refining, transporting, storing, and delivering. The fuel cycle has been estimated to be around 50%—accordingly, for every unit of fuel provided to an end user, approxiately another half unit of fuel is consumed in providing the unit of fuel to the end user. Accordingly, emissions are generated when providing fuel to an end user. Therefore, preventing fuel from evaporating from a leaking fuel filler cap not only prevents direct evaporative emissions, but also prevents the need to replace the fuel evaporating from the leaking cap. By preventing the need to provide replacement fuel, emissions that would result from providing the replacement fuel are eliminated.

The emissions reductions achieved by replacing the failing cap with a passing cap are, for example, estimated, such as by using one or more or methods 300, 400, or 600, discussed below. As another example, leakage of the passing cap may be measured, and emissions reductions achieved by replacing the failing cap with a passing cap may be deemed equal to or based on a difference in the leakage of the failing cap and the leakage of the passing cap. Furthermore, the emissions reductions achieved by replacing the failing cap with a passing cap can be calculated, for example, by considering a parameter of the fuel tank and/or equipment hosting the fuel tank. For example, in the case of a vehicle, the emissions reduction achieved by replacing the failing cap with a passing cap can be calculated based on one or more of the vehicle's location, the vehicle's fuel efficiency, the vehicle's age, the vehicle's make, the size of the vehicle's fuel tank, and weather at the vehicle's location.

The offset credits obtained in step 110 may be obtained from an authority of an emissions trading system, including but not limited to, the Chicago Climate Exchange and the Montreal Climate Exchange. The offset credits may be tradable via an exchange. Accordingly, a party may execute some embodiments of method 100 to obtain an economic return. Alternately, the credits obtained in step 110 may be useable to offset emissions, such as by an emissions emitter subject to a regulatory schema. Thus, some embodiments of method 100 may be executed solely to offset emissions, such as to offset new emissions. For example, if an electrical utility subject to emissions regulations needs to offset emissions from a new power plant, the utility may execute an embodiment of method 100 to offset the power plant's emissions, thereby potentially enabling the utility to build and/or to operate the power plant.

Method 100 is performed for each member of the population of fuel tanks. However, in some embodiments of method 100, steps 102-108 are performed as needed for each fuel tank, and step 110 of obtaining credits is performed once after completion of testing of all of the population's fuel tanks. In other embodiments of method 100, steps 102-108 are performed as needed for each fuel tank, and step 110 of obtaining credits is performed at set intervals, such as at set times or after a predetermined number of fuel filler caps are tested.

As discussed above, step 110 optionally includes obtaining emissions offset credits from the authority of an emissions trading system. Accordingly, step 110 optionally includes obtaining a certification from an emissions trading system authority that execution of method 100 meets the authority's requirements to obtain emissions offset credits. Such certification may be in part or in whole electronically gathered and transmitted. The following is one example of how it could be shown that some embodiments of method 100 meet an authority's requirements to obtain offset credits.

First, as discussed above, in some embodiments of method 100, the fuel filler caps tested in step 102 are limited to fuel filler caps that would not likely otherwise be subject to leakage testing. For example, a party could execute method 100 in an area not currently subject to fuel filler cap testing, such as at a reduced or no cost to the public and/or a responsible government authority. Furthermore, some embodiment of method 100 may be costly to execute. Such costs include, for example, costs of acquiring, installing, and maintaining test equipment, costs of training operators to use the test equipment, labor costs associated with testing fuel filler caps, verification costs, cost of obtaining emissions offset credits, and costs of replacing defective fuel filler caps. Thus, some embodiments of method 100 would likely not be financially viable but for availability of emissions offset credits. Accordingly, such embodiments of method 100 satisfy the additionality requirement.

Second, the emissions reductions achieved by execution of some embodiments of method 100 can be quantified and verified. Specifically, the amount of emissions reductions achieved by replacing failing fuel filler caps can be quantified, and such reductions can be verified, such as via optional step 108.

Third, causing a failing fuel filler cap to be replaced in step 106 will not result in a generation of corresponding additional emissions elsewhere. Thus, the emissions reductions resulting from execution of some embodiments of method 100 are real.

Fourth, as noted above, in some embodiments, a failing fuel filler cap is replaced with a passing cap that is certified to retain its integrity for a specified time period. Thus, execution of such embodiments of method 100 results in permanent emissions reductions.

The exact amount of credits obtained in step 110 may vary based upon factors including the expected life of the replacement good cap, the level of verification performed at step 108, the identity of the equipment (e.g., vehicle such a car or lawnmower) hosting the defective fuel filler cap, etc.

In some embodiments of step 104, a community member may be informed that their fuel filler cap is leaking when the cap passes but has a leakage value between zero and the threshold amount. The community member further can be educated that the passing but leaking fuel filler cap is wasting fuel and thereby wasting money, and that the leaking fuel filler cap is contributing to undesired emissions. For example, the community member may be educated that even a small leak may result in loss of significant amount of fuel, and that a small leak will generally result in as much fuel loss as a large leak over time. The community member may elect to replace the passing but leaking cap to eliminate the negative consequences of the leaking cap. In such case, steps 106-110 are subsequently executed even though the cap passes, such that the cap is replaced and emissions offset credits are obtained.

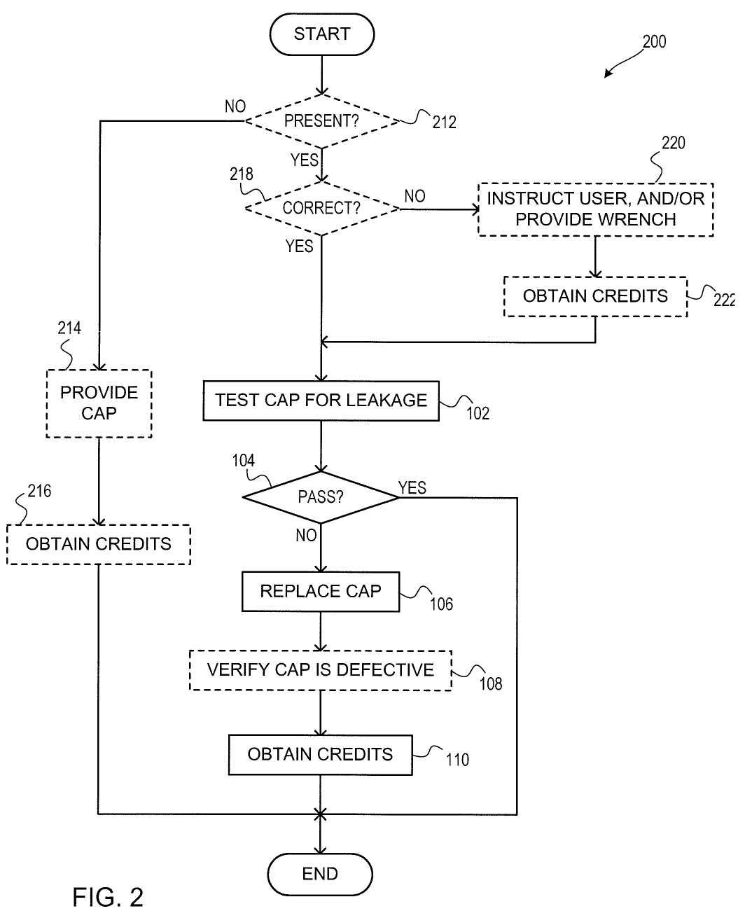

FIG. 2 shows one method 200 of obtaining emissions offset credits by testing fuel filler caps of a population of fuel tanks that includes instances of both leaking and non-leaking fuel filler caps. Method 200 is an embodiment of method 100, FIG. 1, and method 200 includes steps in addition to those of method 100. Specifically, as discussed below, method 200 includes steps 212-216 and/or steps 218-222 in addition to steps 102-110.

Method 200 optionally includes steps 212-216. If method 200 includes such steps, method 200 begins with decision step 212 of determining whether a fuel filler cap is installed on a fuel filler neck of a fuel tank of the population. For example, a vehicle's fuel filler neck is checked to see if a fuel filler cap is installed thereon. Additionally, some embodiments of method 200 include determining whether a compatible fuel filler cap is installed on the fuel filler neck. A compatible fuel filler cap is one having a design that allows the cap to adequatey seal the fuel filler neck. In the case of a vehicle, a compatible fuel filler cap is, for example, a cap intended for use with the particular vehicle.

If the fuel filler cap is missing or incompatible, method 200 proceeds to step 214 where an effective fuel filler cap, such as a new or refurbished fuel filler cap, is provided. For example, in step 214, the user may be provided a zero-leak gas cap, which optionally has a lifetime warranty. Alternately, in step 214, the user may be provided an economic incentive, such as a voucher for a new cap, to obtain a replacement fuel filler cap. Additionally, in some embodiments of step 214, the user is questioned as to why the fuel filler cap is missing. If the user answers that he or she finds it difficult to install the cap, the user is provided a tool, such as a wrench, to help the user install the cap.

Method 200 proceeds from step 214 to step 216 where emissions offset credits are obtained in a manner similar to that of step 110, FIG. 1. The offset credits obtained in step 216 may correspond to the emissions reductions achieved by replacing a missing or incompatible fuel filler cap with a passing fuel filler cap. Additionally, in some embodiments of step 216, additional emissions offsets are obtained if the user is provided a tool to help install the fuel filler cap in step 214.

Method 200 includes steps 218-222 in addition to or as an alternative to steps 212-216. If method 200 includes steps 218-222, method begins with decision step 218 if decision step 212 is not included. Alternately, method 200 reaches decision step 218 if decision step 212 is executed and when the result of decision step 212 is that a compatible fuel filler cap is installed. In step 218, it is determined whether the fuel filler cap is correctly installed. A correctly installed fuel filler cap is, for example, properly threaded and properly torqued. Proper installation may be checked, for example, by visually inspecting the fuel filler cap's installation and/or by physically checking the fuel filler cap's installation. If the cap is incorrectly installed, a remedial action is performed in step 220. Such remedial action includes, for example, asking the user why the fuel filler cap is incorrectly installed, and the depending on the user's answer, instructing the user on the importance of properly installing the fuel filler cap, instructing the user on how to properly install the fuel filler cap, and/or a providing the user a tool, such as a wrench, to aid the user in properly installing the cap. Method 200 proceeds to step 222 where emissions offset credits are obtained in a manner similar to that of step 110. The offset credits obtained in step 222 may correspond to the emissions reductions achieved by henceforth correctly installing a fuel filler cap that was previously incorrectly installed.

If it is determined in decision step 218 that the fuel filler cap is correctly installed or after execution of step 222 or 212, method 200 proceeds to steps 102-110 in the same manner as in method 100, FIG. 1.

Method 200 is performed for each member of the population of fuel tanks. However, in some embodiments of method 200, one or more of the steps of obtaining offset credits 110, 216, 222 are executed once after the completion of testing of all of the population's fuel tanks or after a predetermined interval. Additionally, although steps 110, 216, and 222 are shown as discrete steps, two or more of these steps could be combined into a single step. For example, all applicable offset credits could be obtained in a single, final step of method 200.

Each step of method 100 or 200 may be performed by a single party. Alternately, the steps of method 100 or 200 may be performed by two or more parties. For example, in method 100, step 110 may be performed by a first party, and steps 102-108 may be performed by a second party. Similarly, in method 200, steps 110, 216, and 222 may be performed by a first party, and the remaining steps may be performed by a second party. The second party may perform its respective steps of method 100 or 200 for the first party, such as pursuant to a contract with the first party. The second party is, for example, a retail store or service center that has agreed to test fuel filler caps for the first party, or a non-profit organization that has agreed to test fuel filler caps for the first party in order to achieve environmental benefits resulting from reducing emissions from fuel filler caps.

As discussed above, in some embodiments of method 100 or 200, at least one failing fuel filler cap is transferred or sent to a third party verifier in optional step 108. Such transfer may be accomplished by a party that is different from the party that obtains emissions offset credits in step 110, thereby increasing confidence that the testing of method 100 or 200 is unbiased. For example, if a first party obtains emissions offset credits in step 110 and a second party performs the remainder of the steps in method 100, the second party may directly send a failing fuel filler cap to the third party verifier in optional step 108 without the first party handling the defective cap. Alternately, a failing fuel filler cap may be sent to the third party verifier by the first party.

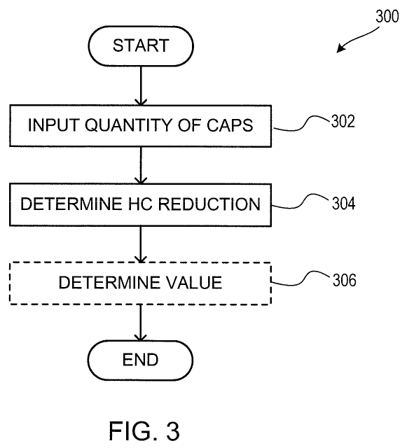

Methods 100 and 200 each include step 110 of obtaining emissions offset credits. As discussed above, emissions reductions generally must be quantified in order to obtain corresponding offset credits. FIG. 3 shows one method 300 of quantifying hydrocarbon reductions for use in step 110 of method 100 or 200. However, hydrocarbon reductions resulting from execution of method 100 or 200 may be quantified using other methods. Method 300 is performed, for example, by a computer executing a software product including instructions, stored on computer readable media, where the instructions, when executed by the computer, perform the steps of method 300. The software product optionally is operable to allow assumptions used in calculations to be manually and/or automatically changed. For example, the software product may be operable to allow a user to manually change the value of constant Evap discussed below, such as by using a keyboard, a touch screen, a voice recongition system, a mouse, and/or a trackball. Some embodiments of the software product are operable to automatically generate and/or submit an application to obtain emissions offset credits, such as hydrocarbon emissions offset credits.

Method 300 begins with step 302 of inputting the quantity of failing fuel filler caps replaced by executing step 106. Step 302 is performed, for example, by a human entering the quantity into a computer configured to execute method 300. As another example, step 302 may be performed by a computer executing method 300 automatically obtaining the quantity from equipment associated with one or more test centers, such as vehicle service facilities, where method 100 or 200 is performed. As yet another example, step 302 may be performed by a computer executing method 300 automatically determining the quantity from test data, where the computer obtains the test data via a temporary or permanent connection to test equipment or from computer readible media physically transferred from test equipment to the computer.

In step 304, the mass or weight of the hydrocarbon reduction achieved by replacing defective fuel filler caps is calculated using EQN. 1 as follows:

HC_{reduction}=(Density)(Comp)(Evap)(Quantity)(Conv) EQN. 1

where HC_{reduction} is the amount of hydrocarbon reduction, in metric tons per year for example, resulting from execution of method 100 or 200. Density is the density of the fuel, such as 0.74 kilograms per Litre in the case of gasoline. Comp is the portion of a unit of measure of the fuel that contains hydrocarbons. If the fuel is gasoline, Comp is for example 86.6%.

Evap is an estimated amount of fuel that evaporates on average each year from a leaking fuel filler cap. Evap may be obtained, for example, from published literature, such a 1997 M. J. Bradley and Associates Study entitled “Protocol for Determination of VOC Reductions from the Replacement of Gas Caps on Light Duty Gasoline Vehicles.” For example, Evap may be estimated at 102.2 Litres in the case of a gasoline powered vehicle's fuel filler cap.

Quantity is the number of caps from step 302, and Cony is an optional conversion factor to obtain desired units. For example, Cony may be equal to 0.001 metric tons per kilogram such that HC_{reduction} is expressed in metric tons per year.

In optional step 306, the value of the hydrocarbon reduction calculated in step 304 may determined by multiplying the market price for hydrocarbon offset credits by the value of HC_{reduction} determined in step 304. For example, if the market value of hydrocarbon offset credits is $8,000 per metric ton—year and the amount of hydrocarbon reduction from step 304 is 692.80 metric tons per year, the value of the hydrocarbon offsets is $5,542,400.

Method 300 may also be adapted to quantify the hydrocarbon reduction achieved by replacing a missing or incompatible fuel filler cap in step 214, FIG. 2. In such case, Evap would be an estimated amount of fuel that evaporates per year as a result of a missing or incompatible fuel filler cap, and Quantity would be the number of times that step 214 is executed. Furthermore, method 300 may be adapted to determine the amount of hydrocarbon reduction achieved in step 220 by instructing a user how to properly install a fuel filler cap and/or providing a wrench to the user in step 220, FIG. 2. In such case, Evap would be an estimated amount of fuel that evaporates each year as a result of an incorrectly installed fuel filler cap, and Quantity would be equal to the number of times that step 220 is executed.

The value of HC_{reduction} determined in EQN. 1 may optionally be adjusted to account for losses due to the fuel cycle in addition to direct evaporative losses by multiplying HC_{reduction} by an appropriate scaling factor, such as 1.5. Additionally, HC_{reduction} may optionally be converted to carbon dioxide equivalents by multiplying HC_{reduction} by an appropriate scaling factor, such as 3.7.

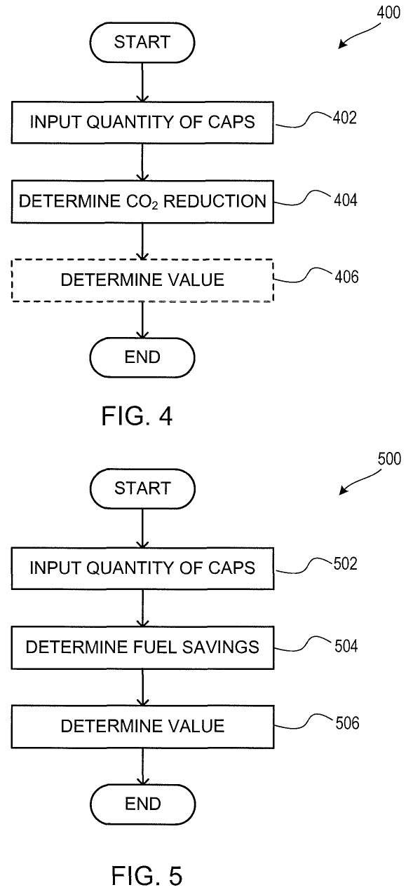

FIG. 4 shows one method 400 of quantifying carbon dioxide offset credits resulting from savings in the fuel cycle for use in step 110 of method 100 or 200. However, carbon dioxide reductions resulting from execution of method 100 or 200 may be quantified using other methods. Method 400 is performed, for example, by a computer executing a software product including instructions, stored on computer readable media, where the instructions, when executed by the computer, perform the steps of method 400. The software product optionally is operable to allow assumptions used in calculations to be manually and/or automatically changed. For example, the software product may be operable to allow a user to manually change the value of constant FC discussed below, such as by using a keyboard, a touch screen, a voice recognition system, a mouse, and/or a trackball. Some embodiments of the software product are operable to automatically generate and/or submit an application to obtain emissions offset credits, such as carbon dioxide emissions offset credits.

Method 400 begins with step 402 of inputting the quantity of failing fuel filler caps replaced in step 106. Step 402 is performed, for example, by a human entering the quantity of caps into a computer configured to executed method 400. As another example, step 402 may be performed by a computer automatically obtaining the quantity of caps from equipment associated with one or more test centers, such as vehicle service facilities, where method 100 or 200 is executed. As yet another example, step 402 may be performed by a computer executing method 400 automatically determining the quantity from test data, where the computer obtains the test data via a temporary or permanent connection to test equipment or from computer readible media physically transferred from test equipment to the computer.

In step 404, the mass or weight of the carbon dioxide reduction is calculated using EQN. 2 as follows:

CO2_{reduction}=(Evap)(P)(FC)(Quantity)(Conv) EQN. 2

where CO2_{reduction} is amount of carbon dioxide reduction, such as in metric tons per year, resulting from replacing leaking fuel filler caps in step 110 of method 100 or 200. Evap is an estimated amount of fuel that evaporates each year from a leaking fuel filler cap, as in method 300 of FIG. 3. Quantity is the number of fuel filler caps inputted in step 402. P is the estimated amount of carbon dioxide produced by producing one measure of fuel. For example, if the fuel is gasoline, P may be 2.33 kilograms per Litre.

FC is the fuel cycle cost. As discussed above, the fuel cycle accounts for energy expenditures associated with exploring, drilling, refining, transporting, storing, and delivering a unit of fuel to an end user. For example, in the case of gasoline, FC may be estimated to be 50%. Accordingly, for each Litre of gasoline provided, an additional half Litre is effectively consumed, such as by exploring, drilling, refining, transporting, storing, and delivering, in order to provide the Litre of gasoline. Thus, as can be observed from EQN. 2, CO2_{reduction} represents carbon dioxide emissions solely due to savings in the fuel cycle.

As in method 300, Cony is an optional conversion factor to obtain desired units. For example, Cony may be equal to 0.001 metric tons per kilogram such that CO2_{reduction} is expressed in metric tons per year.

In optional step 406, the value of the carbon dioxide reduction credits calculated in step 404 may be determined by multiplying the market price for carbon dioxide offset credits by the value of CO2_{reduction} determined in step 404. For example, if the market value of carbon dioxide offset credits is $25 per metric ton-year and the amount of carbon dioxide reduction from step 404 is determined to be 1,256.40 metric tons/year, the value of the carbon dioxide offsets is $31,410.

In a similar manner to that of method 300, method 400 may also be adapted to quantify the carbon dioxide reduction achieved by replacing a missing or incompatible fuel filler cap in step 214, FIG. 2. In such case, Evap would be an estimated amount of fuel that evaporates per year as a result of a missing or incompatible fuel filler cap, and Quantity would be the number of times that step 214 is executed. Furthermore, method 400 may be adapted to determine the amount of carbon dioxide reduction achieved by instructing a user how to properly install a fuel filler cap and/or providing a wrench to user in step 220, FIG. 2. In such case, Evap would be an estimated amount of fuel that evaporates each year as a result of an incorrectly installed fuel filler cap, and Quantity would be equal to the number of times that step 220 is executed.

FIG. 5 shows one method 500 of quantifying the fuel savings achieved by causing replacement of failing fuel filler caps in step 106 of method 100 or 200. Method 500 begins with step 502 of inputting the quantity of defective fuel filler caps caused to be replaced in step 106. Step 502 is performed, for example, by a human entering the quantity of caps into a computer configured to execute method 500. As another example, step 502 may be performed by a computer automatically obtaining the quantity of caps from equipment associated with one or more test centers, such as vehicle service facilities, where method 100 or 200 is executed. As another example, step 502 may be performed by a computer executing method 500 automatically determining the quantity from test data, where the computer obtains the test data via a temporary or permanent connection to test equipment or from computer readible media physically transferred from test equipment to the computer.

In step 504, the amount of fuel saved is calculated using EQN. 3 as follows:

Fuel_Saved=(Evap)(Quantity) EQN. 3

where Fuel_Saved is the amount of fuel saved by executing step 106 of method 100 or 200. As in methods 300 and 400, Evap is an estimated amount of fuel that evaporates each year from a leaking fuel filler cap. Quantity is the number of times that step 106 is executed from step 502.

In step 506, the monetary value of the fuel saved by executing step 106 is calculated by multiplying Fuel_Saved from step 504 by the market value of fuel, such as in dollars per Litre.

In a similar manner to that of method 300 or 400, method 500 may also be adapted to quantify the fuel saved by replacing a missing or incompatible fuel filler cap in step 214, FIG. 2. In such case, Evap would be an estimated amount of fuel that evaporates per year as a result of a missing or incompatible fuel filler cap, and Quantity would be the number of times that step 214 is executed. Furthermore, method 500 may be adapted to determine the amount of fuel saved by instructing a user how to properly install a fuel filler cap and/or providing a wrench to user in step 220, FIG. 2. In such case, Evap would be an estimated amount of fuel that evaporates each year as a result of an incorrectly installed fuel filler cap, and Quantity would be equal to the number of times that step 220 is executed.

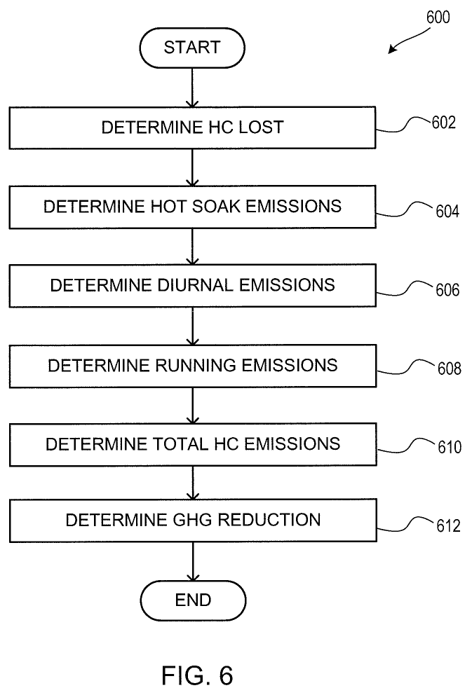

FIG. 6 shows one method 600 of quantifying greenhouse gas emissions reductions for use in step 110 of method 100 or 200 when the population of fuel tanks are vehicle fuel tanks, such as light duty passenger vehicle fuel tanks. However, greenhouse gale reductions resulting from execution of method 100 or 200 may be quantified using other methods. Method 600 is performed, for example, by a computer executing a software product including instructions, stored on computer readable media, where the instructions, when executed by the computer, perform the steps of method 600. The software product optionally is operable to allow assumptions used in calculations to be manually and/or automatically changed. For example, the software product may be operable to allow a user to manually change the value of constant V discussed below, such as by using a keyboard, a touch screen, a voice recongition system, a mouse, and/or a trackball. Some embodiments of the software product are operable to automatically generate and/or submit an application to obtain emissions offset credits, such as greenhouse gas emissions offset credits.

Method 600 begins with step 602 of estimating the amount of hydrocarbons lost due to a leaking fuel filler cap using the following expression:

$$G = 454 W [ \frac{520}{690 - 4 M} ] [ \frac{{P}_{va}}{{P}_{a} - {P}_{va}} ] [ ( \frac{( {P}_{a} - {P}_{1} )}{{T}_{1}} V - {VT}_{1} ) - ( {P}_{a} - {P}_{2} ) \frac{V}{{T}_{2}} ] \qquad EQN . 4$$

where G is the amount of hydrocarbons lost in grams due to a leaking fuel filler cap. W is the liquid density of gasoline in pounds per gallon, M is the molecular weight of gasoline in pounds per pound-mole, Pᵥₐ is the average true vapor pressure in pounds per square inch, Pₐ is the ambient pressure in pounds per square inch, P₁ is the initial true vapor pressure in pounds per square inch, P₂ is the final true vapor pressure in pounds per square inch, T₁ is the initial temperature in degrees Rankine, T₂ is the final temperature in degrees Rankine, and V is equal to 2.46062-0.02139 (PF), where PF is the percent fill of the fuel tank.

Method 600 proceeds from step 602 to step 604 where hot soak emissions are determined using EQN. 5 below. Hot soak emissions result from hot emission control and fuel systems heating the fuel tank after the vehicle is turned off at the end of a trip.

Gₕ=4G/VKT−5% EQN. 5

In EQN. 5, Gₕ is the hot soak emissions in grams per kilometer, G is determined using EQN. 4 above with values appropriate for hot soak emissions, and VKT is vehicle travel distance per day in kilometers. EQN. 5 assumes four trip ends per day as specified by the constant four. However, EQN. 5 may be modified assume a different number of trip ends per day by replacing the constant four with another constant. EQN. 5 includes a five percent correction factor to account for a portion of the emissions that would normally be controlled by the vehicle's carbon canister.

In step 606, diurnal emissions are determined using EQN. 6 below. Diurnal emissions result from heating of the fuel tank due to rising temperatures of a typical day.

G_{d}=G/VKT EQN. 6

In EQN. 6, G_{d} is diurnal emissions in grams per kilometer, G is determined using EQN. 4 above with values appropriate for diurnal emissions, and VKT is vehicle travel distance per day in kilometers.

Running emissions are determined in step 608 using EQN. 7 below. Running emissions result from heat transfer to and from the fuel tank during the vehicle's operation.

Gᵣ=G/1.609344 EQN. 7

In EQN. 7 above, Gᵣ is running emissions in grams per kilometer, and G is determined using EQN. 4 above with values appropriate for running emissions.

Method 600 proceeds from step 608 to step 610 where total hydrocarbon loss is determined using EQN. 8 as follows:

G_{T}=(GₕG_{d}Gᵣ)VKT−5% EQN. 8

where G_{T} is total hydrocarbon lost in grams per year, Gₕ is deter lined from EQN. 5 above, G_{d} is determined from EQN. 6 above, and Gᵣ is determined from EQN. 7 above. VKT is vehicle travel distance per year in kilometers.

In step 612, the greenhouse gas reduction resulting from replacing a defective fuel filler cap is determined using the following expression:

$$C {O}_{2 e} = [ \frac{44 {n}_{voc} {G}_{TA}}{{MW}_{voc}} ] {10}^{- 6} + PE + ML \qquad EQN . 9$$

where CO₂e is the carbon dioxide equivalent greenhouse gas reduction in tonnes per gas leaking gas cap replaced per year due to secondary contributions. G_{TA} is the total hydrocarbon lost per year from EQN. 8 above, n_{voc} is the number of carbon atoms in a molecule of the hydrocarbon or volatile organic compound (8 for gasoline), MW_{voc} is the hydrocarbon's or volatile organic compound's molecular weight (105 grams per mole for gasoline), PE is processing emissions of gasoline (e.g., average of 0.275 tonnes of CO₂e for each tonne of CO₂ emission), and ML is equal to 3.15G_{TA}/1,000,000.

The value of CO₂e determined in step 612 can be used to apply for greenhouse gas emissions offset credits. It should be noted that EQNS. 4-9 may be modified to allow for use of different units. For example, the equations could be modified such that CO₂e determined in EQN. 9 represents the greenhouse gas reduction in tonnes per gas leaking gas cap replaced per day.

As discussed above, engine oil must be changed from time to time. However, many engine owners change their engine's motor oil more frequently than necessary. Indeed, in the case of vehicles, it has been estimated that approximately 70% of motorists in North America change their vehicle's oil more frequently than needed. Businesses that engage in changing oil frequently recommend that engine motor oil be replaced at specific time or use intervals. For example, in the case of vehicles, it is often recommended that motor oil be changed every three months or every three thousand miles, whichever comes first. However, the effective life of engine motor oil is affected by factors besides time and use. For example, in the case of a vehicle's engine, motor oil lifetime is governed by factors including (1) the type of driving, such as city or highway, (2) the load being moved by the vehicle, (3) road conditions, (4) environmental terrain, (5) weather, (6) vehicle mechanical condition, and/or (7) the driver's practices. Accordingly, if an individual changes their engine's oil based on a specific time or use intervals, there is a good chance that the oil is being replaced more frequently than needed, resulting in undesired emissions and waste of resources.

Some vehicles include indicator lights that notify a driver when the vehicle's engine oil needs to be changed. However, notification is commonly triggered by logarithmic programs that have little to do with the motor oil's actual condition. Accordingly, if a vehicle's driver relies on the vehicle's indicator light to determine when to change the vehicle's motor oil, there is a good chance that the driver will change the oil more frequently than needed, resulting in undesired emissions and waste of resources.

Waste motor oil, which is motor oil removed from an engine when changing the engine's oil, is generally considered hazardous waste. For example, waste motor oil may include one or more of the following substances: (1) degraded base oil chemicals, (2) heavy metals such as Barium, Chromium, and Zinc, (3) wear metals from the engine, (4) residual and degraded oil additives, and (5) combustion by-products such as polycyclic aromatic hydrocarbon. Motor oil can greatly harm the environment, and it can pose a threat to human health. Therefore, it would be desirable to reduce the amount of waste motor oil resulting from unnecessary oil changes.

Furthermore, unnecessary oil changes may increase demand for motor oil. Producing motor oil generates emissions, such as hydrocarbons and carbon dioxide. For example, it is estimated that production of a quart of motor oil generates more than 15 pounds of carbon dioxide. Therefore, reducing unnecessary oil changes reduces emissions.

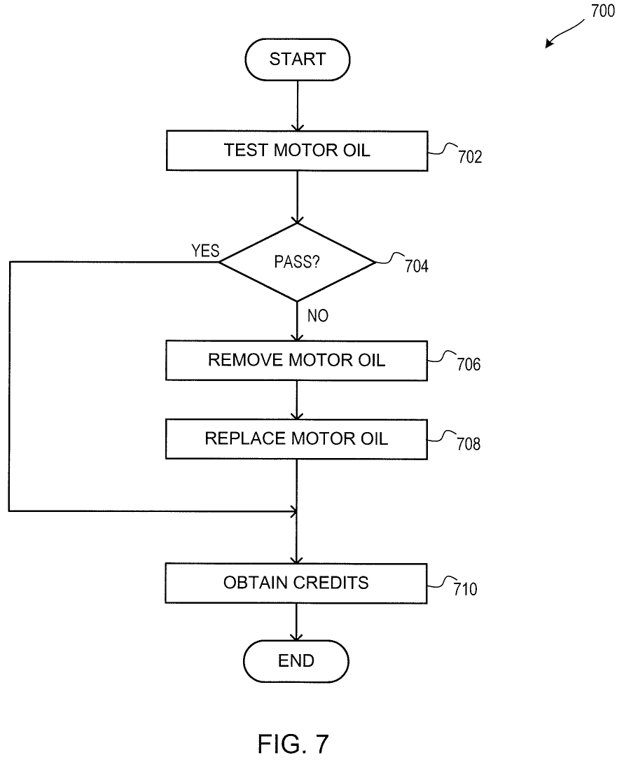

FIG. 7 shows one method 700 of obtaining emissions offset credits by reducing use of engine motor oil. Method 700 begins with step 702 with the test of the motor oil's condition in response to a request to change the engine's motor oil. Such condition includes, for example, the oil's sludge content. An example of step 702 is upon a request to change an engine's oil, dipping a diagnostic test strip in the oil and comparing the strip to a chart to determine the oil's condition. Another example of step 702 is transferring the engine oil onto paper of a diagnostic kit to evaluate the oil's condition. Yet another example of step 702 is evaluating the engine oil's condition using a mass spectrometer.

In decision step 704, it is determined whether the motor oil passes or fails. The motor oil passes if its condition is acceptable, and the motor fails if its condition is unacceptable. An example of step 704 is evaluating the test results from step 702 to determine whether the oil passes or fails. If the motor oil passes, the engine's motor oil is not changed, and operation proceeds to step 710 whereby an unnecessary oil change is thereby avoided.

If the motor oil fails, the motor oil needs changing, and method 700 proceeds to step 706. In step 706, contaminated motor oil is removed from the engine, such as by draining the oil. In an embodiment, compressed air is used to help remove the contaminated motor oil in step 706. Use of compressed air helps remove contaminated oil that would not otherwise be removed when relying on gravity alone to drain the oil. Contaminated oil remaining in the engine will partially contaminate clean oil that is subsequently added to the engine, thereby decreasing the clean oil's life. Accordingly, using compressed air to remove contaminated oil in step 706 advantageously increases the life of the clean replacement oil, thereby helping to reduce the frequency of oil changes and associated consumption of motor oil. One example of an apparatus that may be used to help remove contaminated oil using compressed air is disclosed in U.S. Pat. No. 6,298,947 to Flynn, which is incorporated herein by reference.

In step 708, clean motor oil is added to the engine. In the event compressed air was used to flush contaminated oil from the engine in step 706, some motor oil is injected into the engine using compressed air to prevent a “dry start”, which is an engine start with insufficient motor oil. In embodiments of method 700, the clean oil is reconditioned motor oil. Such reconditioned motor oil is obtained, for example, by reconditioning the contaminated motor oil removed in step 706.

In step 710, emissions offset credits are obtained from the emissions reductions resulting from the reduction in motor oil consumption achieved by executing method 700. In particular, emission reductions may be achieved by preventing unnecessary oil changes resulting from executing method 700. Additionally, emissions reductions may be achieved by using compressed air in step 706, thereby reducing the frequency of required oil changes. Furthermore, emissions offset credits may be obtained for emissions reductions resulting from using reconditioned as opposed to new motor oil in step 708. Examples of the offset credits include hydrocarbon emissions offset credits, carbon dioxide emissions offset credits, carbon dioxide equivalent emissions offset credits, and/or volatile organic compound emissions offset credits.

In some embodiments of method 700, test history data is recorded in step 704 to create an oil change history database for the engine. The test history data includes, for example, the engine's identity, the decision from step 704 as to whether the engine's oil passes or fails, and information identifying when method 700 was executed, such as the date or the engine's mileage upon execution of method 700. For example, in the case of a vehicle, every time method 700 is performed on the vehicle, the vehicle's identification number, the test results of step 704, and the vehicle's mileage may optionally be recorded in step 704 to create an oil test history for the vehicle. An operator may manually create the oil change history database, or a computer may create the oil change history database by automatically obtaining the test history data, such as from test equipment in communication with the computer. The oil change history database can then be evaluated, such as by a computer, to predict when the engine's oil needs to be changed. Because the prediction of when the engine's oil needs to be changed is based upon actual testing of the engine's oil in step 702, the prediction may be more accurate than predictions based upon other factors such as time accrued and/or mileage accrued since the engine's last oil change.

Method 700 may be executed on each engine of a population of engines. However, in some embodiments, steps 702-708 are performed as needed for each engine, and step 710 is performed once after the completion of testing, and replacement if necessary, of the motor oil of all of the population's engines. In yet other embodiments, steps 702-708 are performed as needed for each engine, and step 710 is performed at predetermined intervals.

Each step of method 700 may be performed by a single party. Alternately, method 700 may be performed by a number of parties. For example, step 710 may be performed by a first party, and the remaining steps may be performed by a second party. The second party may perform its respective steps for the first party, such as pursuant to a contract with the first party. The second party is, for example, a vehicle service center.

As discussed above, engine coolant must be replaced from time to time. In the case of vehicles, it is often recommend that coolant be replaced every two years or 30,000 miles, whichever comes first. However, coolant's actual service life is a function of variables in addition to time and use. Accordingly, many engine users replace their coolant more frequently than needed.

Similar to motor oil, waste engine coolant is considered hazardous waste. Furthermore, production of antifreeze for coolant produces emissions and consumes resources (e.g., natural gas). Accordingly, it would be desirable to reduce unnecessary coolant changes to reduce emissions and resource consumption.

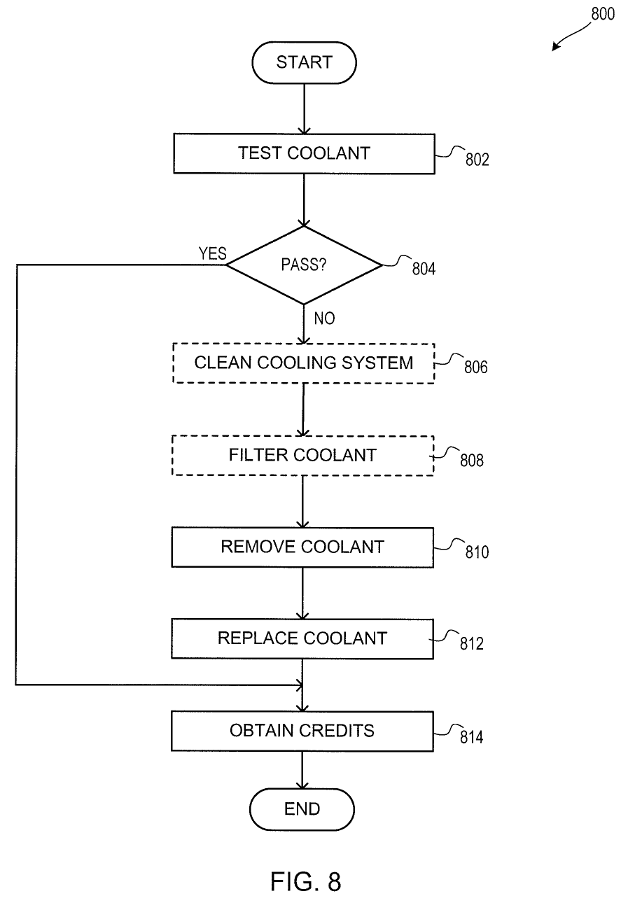

FIG. 8 shows one method 800 of obtaining emissions offset credits by reducing consumption of antifreeze. Method 800 begins with step 802 where the condition of an engine's coolant is tested upon a request to change the coolant in the engine's cooling system. An example of step 802 is dipping a diagnostic strip into coolant to determine properties of the coolant, such as the coolant's freezing point, boiling point, and/or corrosion protection capability. Another example of step 802 is transferring the coolant onto paper of a diagnostic kit and evaluating the coolant's condition. Yet another example of step 802 is evaluating the coolant's condition using a mass spectrometer.

In decision step 804, it is determined whether the coolant passes or fails. The coolant passes if its condition is acceptable. Conversely, the coolant fails if its condition is unacceptable. If the coolant passes, the coolant does not need changing, and method 800 proceeds to step 814, thereby preventing an unnecessary coolant change.

If the coolant is determined to fail in step 804, the coolant needs to be changed, and method 800 proceeds from decision step 804 to optional step 806. In step 806, the engine's cooling system is cleaned, such as by using a cleaning solution that does not require neutralization. Cleaning the cooling system may remove rust, scale, and/or sludge, thereby potentially improving cooling system and engine performance.

Optional step 808 follows optional step 806. In step 808, the coolant is filtered to remove particles, such as particles dislodged during step 806, to facilitate recycling or reconditioning of the coolant. Particles remaining in the coolant may clog a recycling machine's filters, thereby impeding recycling.

Step 810 follows step 804, 806, or 808, depending on whether one or both of optional steps 806 or 808 are performed. In step 810, coolant is removed or drained from the cooling system. Compressed air is optionally used to remove coolant in step 810, thereby increasing the amount of coolant removed from the cooling system. In a manner similar to that discussed above with respect to method 700, contaminated coolant remaining in the cooling system can contaminate replacement, clean coolant, and thereby shorten the replacement coolant's life. Accordingly, using compressed air to remove coolant in step 810 may increase the life of clean, replacement coolant, thereby reducing consumption of antifreeze.

In step 812, replacement, clean coolant is added to the engine. In some embodiments, the replacement coolant includes reconditioned antifreeze. The reconditioned antifreeze is, for example, obtained by reconditioning antifreeze from the coolant that was removed from the engine in step 810. Using reconditioned antifreeze further reduces the need to produce new antifreeze and may enable obtaining additional emissions offset credits. It has been estimated that every gallon of coolant that is reused prevents the production of 15 pounds of carbon dioxide.

In step 814, emissions offset credits are obtained for emissions reductions resulting from executing method 800. Such reductions, for example, result from preventing unneeded coolant changes by executing method 800, use of reconditioned as opposed to new antifreeze, and/or extending the time interval between coolant changes by using compressed air in step 810. Examples of the offset credits include hydrocarbon emissions offset credits, carbon dioxide emissions offset credits, carbon dioxide equivalent emissions offset credits, and/or volatile organic compound emissions offset credits.

In some embodiments of method 800, test history data is recorded in step 804 to create a coolant change history database for the engine. The test history data includes, for example, the engine's identity, the decision from step 804 as to whether the engine's coolant passes or fails, and information identifying when method 800 was executed, such as the date or the engine's mileage upon execution of method 800. For example, in the case of a vehicle, every time method 800 is performed on the vehicle, the vehicle's identification number, the test results of step 804, and the vehicle's mileage may optionally be recorded in step 804 to create a coolant test history for the vehicle. An operator may manually create the coolant change history database, or a computer may create the coolant change history database by automatically obtaining the test history data, such as from test equipment in communication with the computer. The coolant change history database can then be evaluated, such as by a computer, to predict when the engine's coolant needs to be changed. Because the prediction of when the engine's coolant needs to be changed is based upon actual testing of the engine's coolant in step 802, the prediction may be more accurate than predictions based upon other factors such as time accrued and/or mileage accrued since the engine's last coolant change.

Method 800 may be executed on each engine of a population of engines. However, in some embodiments, steps 802-812 are performed as needed for each engine, and step 814 is performed once after the completion of testing, and replacement if necessary, of the coolant of all of the population's engines. In yet other embodiments, steps 802-812 are performed as needed for each engine, and step 814 is performed at predetermined intervals.

Each step of method 800 may be performed by a single party. Alternately, method 800 may be formed by a number of parties. For example, step 814 may be performed by a first party, and the remaining steps may be performed by a second party. The second party may perform its respective steps for the first party, such as pursuant to a contract with the first party. The second party is, for example, a vehicle service center.

As discussed above, portable fuel containers are widely used to transport and store fuel. One common example of a portable fuel container is a fuel can used for fueling equipment such as lawn mowers, string trimmers, edgers, blowers, snow blowers, and generators. However, portable fuel containers are generally prone to leak vapors of the fuel stored therein, and thereby cause evaporation of the fuel. The evaporated fuel constitutes undesired emissions. Additionally, fuel evaporation results in waste of fuel and generation of emissions from the fuel cycle when producing additional fuel to replace the fuel lost due to evaporation.

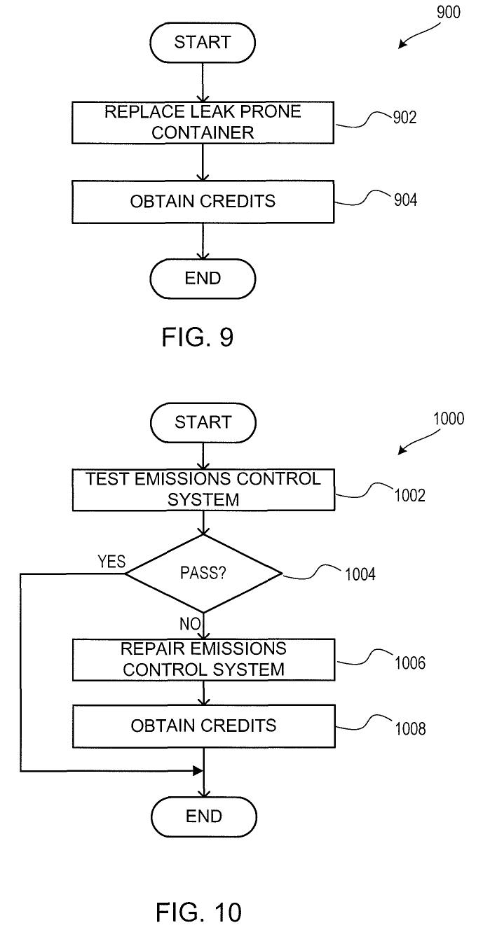

FIG. 9 shows one method 900 of obtaining emissions offset credits by reducing evaporation of fuel from portable fuel containers. Method 900 begins with step 902 where a leak prone portable fuel container that would likely not otherwise be replaced is replaced with a low leak fuel container. A low leak fuel container has negligible leakage, and may be certified to substantially prohibit evaporation for a certain amount of time. An example of step 902 is establishing a program where fuel container owners can exchange their leak-prone fuel containers with low leak fuel containers at reduced or no cost. Another example of step 902 is providing a low leak fuel container at no charge with the purchase of an apparatus, such as a lawnmower, requiring use of a portable fuel container.

In step 904, emissions offset credits are obtained from the emissions reductions resulting from replacing leak prone fuel containers that would likely not otherwise be replaced with low leak fuel containers. Such replacements prevent emissions that would otherwise result from continued use of the leak prone fuel containers. Examples of the offset credits include hydrocarbon emissions offset credits, carbon dioxide emissions offset credits, or carbon dioxide equivalent emissions offset credits. In embodiments of method 900, step 902 is performed a plurality of times, and step 904 is periodically performed at predetermined intervals or after the conclusion of performing all instances of step 902.

Many engines include an emissions system or an emissions control system to reduce emissions generated from the engine. For example, most modern passenger vehicles have an emissions control system including components such as a catalytic converter and an oxygen sensor to reduce emissions generated from the engine. However, components of emissions control systems generally fail over time. Accordingly, an engine may be generating more emissions than necessary due to failure of one or more components of its emissions control system.

FIG. 10 shows one method 1000 of obtaining emissions offset credits by repairing an engine's emissions control system. An engine's emissions control system includes, for example, components such as a fuel filler cap, hoses, gaskets, fittings, valves, canisters, fuel tanks, etc. Method 1000 begins with step 1002 where the engine's emission control system is tested. Step 1002 is, for example, performed only on an emission control system that would likely not otherwise be tested but for execution of method 1000.

In some embodiments of step 1002, the emission control system is tested by a technician. For example, a technician may test the integrity of the engine's evaporative emissions control system using a pressure test instrument. Evaporative emissions control systems commonly include components such as hoses, gaskets, fittings, valves, canisters, etc. that can leak. For example, statistical data from the California Bureau of Automotive Repairs shows that a high percentage of certain tested vehicles have a leaking emissions control system hose. The pressure test instrument, for example, pressurizes the evaporative emissions control system with a gas, such as nitrogen or air. The pressure test instrument may optionally inject a gas that can be detected by a technician, such as smoke, to assist in detecting leaks. In some embodiments of step 1002, pressurized gas is introduced into an emission control system via an opening in a zero leak fuel filler cap installed on the engine's fuel filler neck.

In some embodiments of step 1002, the engine's emission control system is tested with the aid of diagnostic equipment residing on the equipment hosting the engine. For example, a vehicle's emission control system could be tested in step 1002 with the help of the vehicle's on-board diagnostic equipment, such as OBD-I, OBD-II, or OBD-III on-board diagnostic equipment. A technician may access the on-board diagnostic equipment, such as by coupling a test instrument with the equipment, to obtain diagnostic data that may be useful in evaluating the emission control system's status.

Some embodiments of step 1002 include obtaining on-board diagnostic system data without a technician's assistance. For example, in manners similar to that discussed above with respect to FIG. 1, a vehicle's on-board diagnostic equipment may automatically transmit diagnostic data to an external system, on-board diagnostic equipment may be monitored via a data logger, or diagnostic data may be obtained via a self service test kiosk.

If an engine's emission control system is determined to be leaking in step 1002, the engine's fuel filler cap can optionally be replaced with a plug (e.g., a zero leak fuel filler cap known not to leak) to help determine the source of the leak. If testing subsequently shows that there is no longer a leak after replacing the cap with a plug, it can be concluded that the fuel filler cap was the source of the leak. Conversely, if testing subsequently show there is still a leak after replacing the cap with a plug, it can be concluded that there is a leak in the emissions control system unrelated to the fuel filler cap.

Operation proceeds from step 1002 to decision step 1004 where the results from step 1002 are evaluated to determine whether the emissions control system passes. An example of step 1004 is a pressure test instrument used in step 1002 indicating whether an evaporative emissions control system passed or failed. If the emission control system passes, method 1000 ends. Otherwise, method 1000 proceeds to step 1006.

In step 1006, the defective emissions control system is repaired, or a party (e.g., engine owner) is provided an incentive to have the emissions control system repaired. An example of step 1006 is replacing a leaking hose in an engine's evaporative emissions control system. Another example of step 1006 is providing an economic incentive to an owner of engine having a defective emissions control system to have the system repaired.

In step 1008, emissions offset credits are obtained from the emissions reductions resulting from repairing emissions control systems that would likely not otherwise be repaired but for execution of method 1000. Repair of the emissions control systems prevents generation of emissions that would result if the emission control systems were not repaired. Examples of the offset credits include hydrocarbon emissions offset credits, carbon dioxide emissions offset credits, or carbon dioxide equivalent emissions offset credits. In some embodiments of method 1000, steps 1002-1006 are performed a plurality of times, and step 1008 is periodically performed at predetermined intervals or after the conclusion of performing all instances of steps 1002-1006.

It should be noted that method 1000 need not necessarily include steps 1002 and 1004. In particular, method 1000 could be modified to repair or caused to be repaired emissions control systems that are already known to be defective and obtain corresponding emissions offset credits. For example, in an embodiment of method 1000, steps 1002 and 1004 are omitted, and step 1006 includes providing an economic incentive to an owner of engine that has failed a regulatory required emissions test to conduct emissions control system repairs beyond those required by regulations.

Method 1000 could, for example, be executed by a party in an area where engine emission control systems are or are not otherwise likely to be subject to testing. For example, a party could offer to perform method 1000 (or a subset of method 1000) in an area where engine emission control systems are not otherwise subject to mandatory testing at a reduced cost or at no cost to the public and/or a responsible governmental authority. As another example, a party could offer to replace an existing emissions control system test program with all or part of method 1000 at a reduced cost or at no cost to the public and/or a responsible governmental authority.

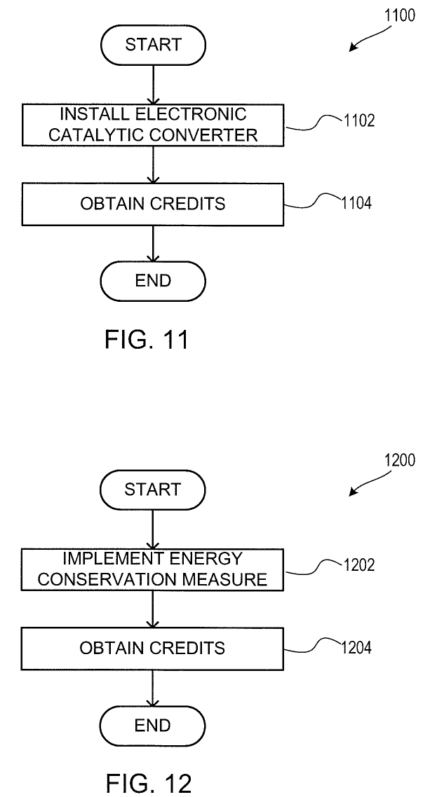

FIG. 11 shows one method 1100 of obtaining emissions offset credits by installing an electronic catalytic converter in series with the fuel intake line of an internal combustion engine. Method 1100 begins with step 1102 of installing an electronic catalytic converters in series with the fuel intake lines of an internal combustion engine that likely would not have an electronic catalytic converter installed thereon but for execution of method 1100. An example of step 1102 is providing an economic incentive for an engine owner to install an electronic catalytic converter in the fuel intake line of their engine.

Installing an electronic catalytic converter in series with an engine's fuel intake line increases the efficiency and/or reduces emissions generated by the engine. In step 1104, emissions offset credits are obtained from the emissions reductions corresponding to the efficiency increase and/or emissions reduction resulting from installing the electronic catalytic converter in step 1102. Examples of the offset credits include hydrocarbon emissions offset credits, carbon dioxide emissions offset credits, or carbon dioxide equivalent emissions offset credits. In embodiments of method 1100, step 1102 is performed a plurality of times, and step 1104 is periodically performed at predetermined intervals or after the conclusion of performing all instances of step 1102.

FIG. 12 shows one method 1200 of obtaining emissions offset credits by implementing an energy conservation measure and/or by installing a renewable energy source. Method 1200 begins with step 1202 of implementing an energy conservation measure and/or installing a renewable energy source. An example of step 1202 is retrofitting a building's incandescent lighting with compact fluorescent lighting. Another example of step 1202 is installing photovoltaic cells or a wind turbine to provide electric power to a building. Yet another example of step 1202 is replacing a building's relatively inefficient gas fired furnace with a high efficiency gas fired furnace.

In step 1204, emissions offset credits are obtained from the emissions reductions corresponding to the implementation of an energy conservation measure and/or installing a renewable energy source in step 1202. Examples of the offset credits include hydrocarbon emissions offset credits, carbon dioxide emissions offset credits, or carbon dioxide equivalent emissions offset credits. For example, if a 5.2 killowatt phovoltaic electric generation system is installed on a house, it may be estimated that the system prevents the emissions of 353,213 pounds of carbon dioxide as well as 2,034 pounds of nitrous oxides and sulfur oxides, and corresponding emissions offset credits may be obtained. In embodiments of method 1200, step 1202 is performed a plurality of times, and step 1204 is periodically performed at predetermined intervals or after the conclusion of performing all instances of step 1202.

A number of methods of obtaining emissions offset credits are discussed above. Each of these methods includes a step of obtaining emissions offset credits. In order to obtain such credits, specific data generally must be presented to an emissions trading system authority. Additionally, the authority may further require the data to be formatted in a specific manner. For example, an emissions trading system authority may require an emissions offset credit application to include information such the emissions reduction specified as a carbon dioxide equivalent reduction, geographic location of the emissions reduction, and the date in which the emissions reduction occurred.

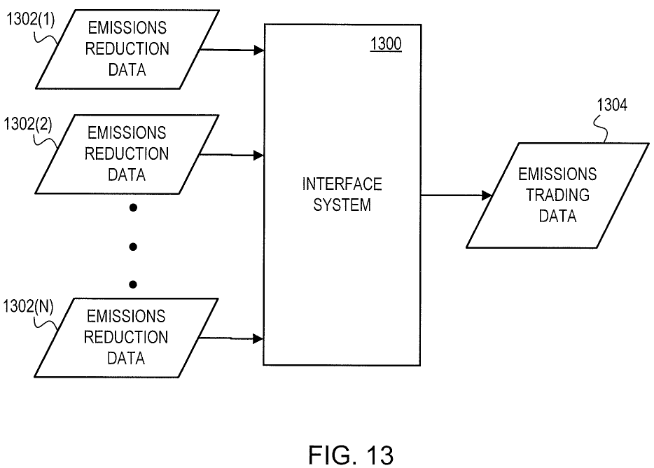

FIG. 13 shows one interface system 1300 that can be used to facilitate obtaining emissions offset credits by providing required data in a form needed to obtain credits from an emissions trading system authority. In particular, system 1300 gathers emissions reduction data 1302 (e.g., fuel filler cap test data, test data concerning other components of an emissions control system, and/or number of leaking fuel filler caps replaced) from one or more sources and converts or transforms the data into emissions trading data 1304 that is suitable for use in obtaining emissions offset credits. Emissions trading data 1304 includes, for example, data required to be included in an emissions offset credit application. Emissions trading data 1304 may optionally be in the form of a credit exchange report which can be submitted (e.g., electronically) to an emissions trading system authority in order to obtain emissions offset credits.

FIG. 13 shows system 1300 receiving emissions reduction data 1302 from a number of sources. Each source, for example, represents a different test site, such as a site where one or more of methods 100, 200, 700, 800, 900, 1000, 1100, or 1200 are performed. However, some embodiments of system 1300 obtain data from only a single source. Additionally, although FIG. 13 shows system 1300 providing a single set of emissions trading data 1304, some embodiments of system 1300 provide a number of sets of emissions trading data 1304, such as a respective set for each of a number of different emissions trading system authorities.

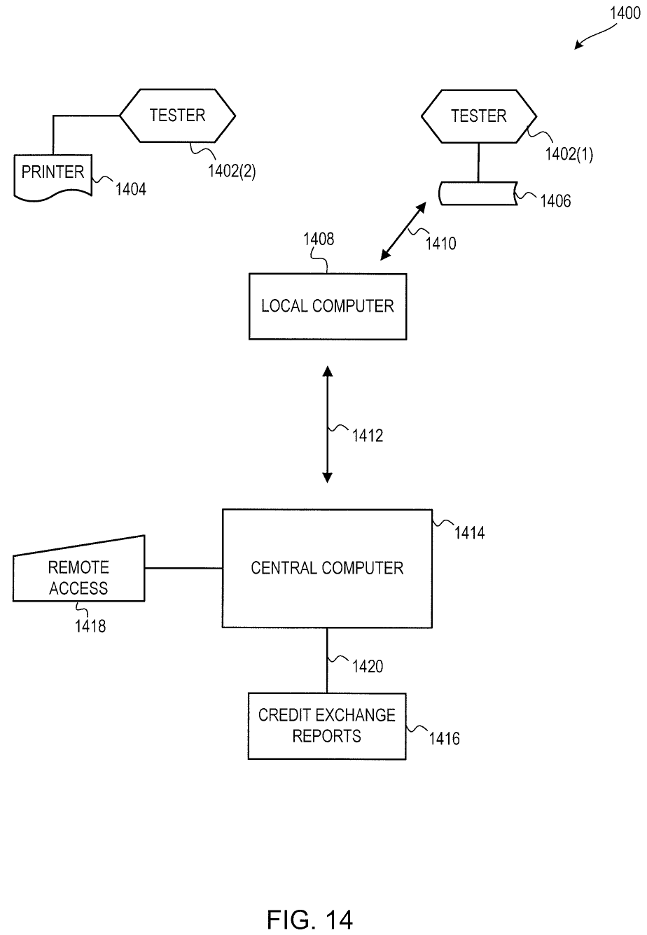

FIG. 14 shows one interface system 1400 for gathering emissions reduction data and converting the data into emissions trading data. System 1400, which is an embodiment of system 1300 of FIG. 13, gathers emissions reduction data from testers 1402 and generates corresponding credit exchange reports 1416 that may be submitted to an emissions trading system authority in order to obtain emissions offset credits. Additionally, some embodiments of system 1400 are operable to perform one or more of the following processes: (1) auditing of test data, (2) quality checking of test data, and (3) dissemination of test data.

System 1400 includes one or more local computers 1408 for gathering and optionally storing emissions reduction data from testers 1402, as well as a central computer 1414 for generating credit exchange reports. Central computer 1414 optionally additionally consolidates and stores test data from local computers 1408. Although only one local computer 1408 is shown in FIG. 14, system 1400 may have any number of local computers. Local computers 1408 are, for example, located at respective test sites, such as automobile service facilities. Central computer 1414 is, for example, located at a central site, such as a company's head office or data center.

Local computers 1408 are, for example, personal computers and/or servers each including a processor, memory, data storage (e.g., hard drive, tape drive), and an input/output system. As another example, local computers 1408 may be specially designed for use in system 1400. Local computers 1408 optionally include software allowing a user to maintain and/or report gathered test data, and in some embodiments, predict or forecast future test results.

Testers 1402 generate emissions reduction test data characterizing an emissions reduction activity. For example, testers 1402 may include fuel filler cap test equipment, such as the Waekon Corporation FPT2600E Handheld Fuel Cap Tester and/or the Waekon FPT27 Electronic Fuel Cap tester discussed above with respect to FIG. 1. In such case, test data may include fuel filler cap integrity data (e.g., whether the cap passes or fails or a numerical cap leakage value), information on the number of times a cap has been tested, identity of equipment hosting the fuel filler cap (e.g., make, model, and year of a vehicle), and/or geographic location of the test.

As another example, testers 1402 may include a vehicle's on-board diagnostic equipment discussed above with respect to FIG. 10. The vehicle's on-board diagnostic equipment may be directly coupled with a local computer 1408 to transfer test data to the local computer 1408. Additionally or alternately, the on-board diagnostic equipment may transfer test data to an external system, such as via remote transmission, a data logger, and/or a self-service test kiosk, as discussed above. The external system, in turn transfers the test data to local computer 1408 and/or central computer 1414 for use as emissions reduction data. As yet another example, testers 1402 may include a pressure test instrument discussed above with respect to FIG. 10.

One or more testers 1402 are optionally communicatively coupled with local computer 1408 via a respective interface 1410. Each interface 1410 is a system for transmitting data as known in the art, such as a universal serial bus connection, a RS 232 serial connection, a wired Ethernet connection, or a wi-fi connection. Coupling of testers 1402 with local computer 1408 advantageously allows for transfer of emissions reduction data from testers 1402 to local computer 1408. Such transfer is automatic in some embodiments. For example, local computer 1408 may periodically poll testers 1402 for new emissions reduction data and download new data as it is identified. As another example, emissions reduction data may be automatically transferred from testers 1402 to local computer 1408 on a periodic basis and/or after accumulation of a threshold amount of data in a respective local storage 1406 of a tester 1402.

Testers 1402 and local computers 1408 that are communicatively coupled each include appropriate software to facilitate data transfer via an interface 1410. For example, an embodiment of tester 1402 may include software operable to store emissions reduction data in internal storage 1406, convert the stored data to a form compatible with local computer 1408, and transfer the stored data via an interface 1410. Local computer 1408 may include, for example, software operable to transfer data via interface 1410 using industry standard protocols with optional data verification and redundancy checks. Local computer 1408 may also include software for converting emissions reduction data from testers 1402 into a form amenable for storage, manipulation, and/or reporting.

In some embodiments of system 1400, data and/or commands may be transferred from local computer 1408 to testers 1402 via interfaces 1410. For example, local computer 1408 may transmit upgraded software or calibration information to testers 1402. As another example, local computer 1408 may transmit commands requesting a tester to start a test or to stop a test, thereby enabling local computer 1408 to control at least some aspects of one or more testers 1402, such as to perform one or more of methods 100, 200, 700, 800, 900, 1000, 1100, or 1200 discussed above. In particular, in some embodiments of system 1400, one or more of testers 1402, local computers 1408, or central computer 1414 are operable to execute a computer program stored on a computer readable medium to perform at least some steps of one or more of methods 100, 200, 700, 800, 900, 1000, 1100, or 1200.

In some embodiments of system 1400, at least some emissions reduction data is transferred from one or more testers 1402 to local computer 1408 without the use of an interface 1410. For example, a user may manually enter emissions reduction data (e.g., whether a fuel filler cap passes or fails) into local computer 1408, such as via a keyboard or mouse. As another example, local computer 1408 may have voice recognition capability enabling local computer 1408 to record test data spoken by a human (e.g., a technician conducting a test). Furthermore, some embodiments of system 1400 may include a optical character recognition device coupled to local computer 1408 enabling local computer 1408 to read test data from a written test report, such as generated by a printer 1404 coupled to a tester. As yet another example, one or more testers 1402 may encode test data on a medium, such as using bar code, radio frequency identification, or magnetic storage techniques, and local computer 1408 may read the medium to obtain the test data.

Each local computer 1408 is coupled to central computer 1414 via a respective interface 1412. Central computer 1414 may be a server located at a central facility. However, central computer 1414 may include a number of computers, which may be located at a common location or geographically dispersed. For example, central computer 1414 may be embodied by a network of computers connected via the internet. Central computer 1414 includes a processor, memory, storage, and an I/O system.

Interfaces 1412 may be communications systems or methods for transmitting data as known in the art, such as for transmitting data over long distances. For example, an interface 1412 may represent a dedicated a T1 circuit, a virtual private network operating on the internet, a wireless data connection (e.g., cellular or satellite), a batch transfer of data over a temporary connection (e.g., via a telephone modem or an internet file transfer protocol session). Alternately, an interface 1412 may represent physical transfer of a medium embodying test data, such as shipment of a printed test report or magnetic tape. Each local computer 1408 and central computer 1414 include, for example, software facilitating secure communication therebetween.

Central computer 1414 generates credit exchange reports 1416 from emissions reduction data from local computers 1408. Data included on credit exchange reports 1416 is, for example, determined at least in part by one or more of methods 300, 400, 500, or 600 discussed above. Credit exchange reports 1416 may include information such as the quantity of emissions reduction achieved, location of the emissions reduction, and the date of the emissions reduction. Some embodiments of system 1400 are operable to produce a number of credit exchange reports 1416, each having appropriate data and being appropriately formatted for submission to a respective emissions trading system authority. As discussed above, central computer 1414 may optionally be operable to consolidate and store emissions reduction data from local computers 1408.

In some embodiments of system 1400, central computer 1414 further has the capability to perform at least one of the following processes: (a) manipulation of consolidated test data, (b) reporting of test data, (c) generation of all necessary documentation to support emissions offset credit processing with an emissions trading system authority, (d) support of remote access 1418, such as to allow a third party (e.g., an auditing entity or a government entity) access to data, and (e) automatically apply for emissions offset credits from an emissions trading system authority, such as via an interface 1420.

Some embodiments of system 1400 advantageously include functionality to facilitate calibration of testers 1402. For example, software included on one or more of testers 1402, local computers 1408, or central computer 1414 may track and/or maintain calibration results for testers 1402 in order to help ensure testing accuracy. Further, in some embodiments of system 1400 that are configured and arranged to be used with method 100 or 200, such embodiments are operable to track and report specific fuel filler caps that were replaced. In these embodiments, test data may be tied to specific fuel filler caps and used to obtain emissions offset credits from an emissions trading system authority.

Although system 1400 has been described above with certain functions being performed by each of testers 1402, local computers 1408, and central computer 1414, functionality may be distributed among the elements of system 1400 in a different manner. For example, at least some aspects of generating emissions trading data may be performed on local computers 1408 and/or testers 1402 instead of central computer 1414. Indeed, all required functional of central computer 1414 may be integrated into local computers 1408 and/or testers 1402 such that central computer 1414 can be omitted. Conversely, functionality of local computers 1408 may be incorporated into testers 1402 and/or central computer 1414 such that local computers 1408 can be omitted. In such embodiments, testers 1402 could for example directly generate credit exchange reports 1416 and/or communicate with an emissions trading system authority.

It is envisioned that two or more of the methods of obtaining emissions offset credits discussed herein may be executed together as part of a common program or procedure. For example, method 100 or 200 may be performed whenever method 700 or 800 is performed. Additionally, one or more of the methods of obtaining emissions offset credits discussed herein may be performed when performing an activity other than those discussed herein. For example, an automotive service facility may execute method 100 or 200 on any vehicle brought to the facility for a tire rotation or an oil change. Furthermore, emissions offset credits can be obtained by performing additional emissions reductions activities, such as checking a vehicle's emission system, tire pressure, air filter, and/or brake system. Such additional emissions reduction activities could be performed while executing one of the methods (e.g., 100, 200, 700, 800, 900, 1000, 1100, 1200) discussed herein.

Furthermore, it should be noted that one or more of the methods of obtaining emissions offset credits discussed herein may be adopted such that they are executed only if they are economical. For example, a method may be executed only in the case where the value of emissions offset credits to be earned from the method exceeds the cost of executing the method.

As a particular example, method 100 could be modified as follows. First, the cost of replacing the fuel filler cap is valuated. Such cost includes, for example, the cost of providing a fuel filler cap, costs associated with testing and replacing the cap, and/or overhead associated with testing and replacing the cap. Next, an amount of emissions that corresponds to an emissions offset credit having a monetary value equal to the cost of replacing the fuel filler cap is calculated. An emissions threshold that an object having a fuel container (e.g., a motor vehicle, a portable fuel container, a lawn mower, an airplane) would have to reach to meet the amount of emissions is estimated. The fuel filler cap's leakage is measured, where the leakage does not necessarily have to include an amount required to open a fuel filler vent in the case of a pressure overload. The fuel filler cap (good or bad) is replaced only if its measured leakage exceeds the emissions threshold. Accordingly, the fuel filler cap is replaced only if the value of emissions offset credits to be earned by replacing the cap exceeds the cost of replacing the cap. This modification of method 100 may advantageously result in replacing a leaking fuel filler cap whenever it is economical to do so, regardless of whether the fuel filler cap has a leakage that exceeds a particular standard.

Emissions can also be reduced and corresponding emissions offsets can be obtained by causing a fuel powered machine (e.g., a gasoline or diesel fuel powered motor vehicle) to operate more efficiently. For example, an engine's fuel system can be cleaned, such as by using a cleaning instrument and/or a cleaning solution, to cause the engine to operate more efficiently. Emissions offset credits corresponding to the resulting increase in efficiency can subsequently be obtained. As another example, a vehicle's differential, manual transmission, and/or power steering system can be cleaned such that the vehicle operates more efficiently. Emissions offset credits corresponding to the resulting increase in the vehicle's efficiency can be obtained.

Changes may be made in the above methods and systems without departing from the scope hereof. It should thus be noted that the matter contained in the above description or shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. A method for reducing emissions from a fuel filler cap, comprising:
valuating a cost of replacing the fuel filler cap;
calculating an amount of emissions that corresponds to an emissions offset credit having a monetary value equal to the cost;
estimating an emissions threshold that an object having a fuel container would have to reach to meet the amount of emissions;
measuring a leakage amount of the fuel filler cap; and
replacing the fuel filler cap when the measured leakage amount exceeds the emissions threshold.

2. The method of claim 1, further comprising applying for additional emissions offset credits corresponding to an amount by which the leakage amount exceeds the emissions threshold.

3. The method of claim 1, wherein the step of calculating is based on at least a market value of the emissions offset credits.

4. The method of claim 1, wherein the step of estimating is based on at least a parameter of a fuel container hosting the fuel filler cap.

5. The method of claim 1, wherein the object having a fuel container is a motor vehicle.

6. The method of claim 1, wherein the object having a fuel container is selected from the group consisting of a fuel can, a lawn mower, and an airplane.

7. A method for obtaining emissions offset credits by testing a population of fuel tanks that includes instances of both leaking and non-leaking fuel filler caps, comprising:
testing each fuel filler cap for leakage;
determining that the fuel filler cap passes when the fuel filler cap's leakage is below a threshold amount;
determining that the fuel filler cap fails when the fuel filler cap's leakage is above the threshold amount; and
when the fuel filler cap fails,
replacing the fuel filler cap, and
obtaining emissions offset credits for emissions reductions resulting from replacing the fuel filler cap.

8. The method of claim 7, wherein the step of obtaining comprises a step of calculating the emissions reductions resulting from replacing the fuel filler cap.

9. The method of claim 8, wherein the step of calculating is based on at least one parameter of a fuel tank of the population of fuel tanks.

10. The method of claim 8, further comprising replacing the fuel filler cap with a replacement fuel filler cap, and wherein the step of calculating comprises a step of measuring a difference in leakage between the fuel filler cap and the replacement fuel filler cap.

11. The method of claim 7, wherein the step of obtaining emissions offset credits comprises a step of obtaining the emissions offset credits from an emissions trading system authority.

12. The method of claim 7, wherein the emissions offset credits are useable to offset emissions from an emissions emitter subject to a regulatory schema.

13. The method of claim 7, wherein the emissions offset credits are tradable via an exchange.

14. The method of claim 7, wherein the step of obtaining emissions offset credits comprises a step of quantifying a reduction in at least one emissions type resulting from replacing the fuel filler cap.

15. The method of claim 7, wherein the emissions offset credits are selected from the group consisting of hydrocarbon emissions offset credits, carbon dioxide emissions offset credits, and carbon dioxide equivalent emissions offset credits.

16. The method of claim 7, wherein:
the step of obtaining is performed by a first party; and
the steps of testing, determining, and replacing are performed by a second party.

17. The method of claim 16, wherein the second party is selected from the group consisting of an automotive service facility, a retail store, and a non-profit organization.

18. The method of claim 16, wherein the second party is an automobile service facility, and the second party performs the steps of testing, determining, and replacing on at least some vehicles brought to the service facility for service.

19. The method of claim 16, wherein the second party performs the steps of testing, determining, and replacing for the first party.

20. The method of claim 7, wherein the step of testing is performed in response to a community member voluntarily requesting that their fuel tank's fuel filler cap be tested for leakage.

21. The method of claim 7, wherein the step of replacing the fuel filler cap comprises replacing the fuel filler cap with a replacement fuel filler cap having a lifetime warranty.

22. The method of claim 7, further comprising recycling a fuel filler cap that is replaced and obtaining additional emissions offset credits for emissions reductions resulting from recycling the fuel filler cap.

23. The method of claim 7, further comprising a step of securing a replacement fuel filler cap with a tether.

24. The method of claim 7, wherein the step of replacing the fuel filler cap comprises a step of providing an economic incentive for a community member to replace the fuel filler cap.

25. The method of claim 24, wherein the economic incentive is a voucher enabling the community member to obtain a replacement fuel filler cap at reduced or zero cost.

26. The method of claim 7, further comprising a step of re-testing the fuel filler cap to verify that the fuel filler cap's leakage is above the threshold amount.

27. The method of claim 7, further comprising a step of retaining a fuel filler cap that is replaced for future auditing.

28. The method of claim 7, further comprising a step of transferring a fuel filler cap to a third party verifier for verification that the fuel filler cap's leakage is above the threshold amount.

29. The method of claim 28, wherein:
the step of obtaining is performed by a first party;
the steps of testing, determining, and replacing are performed by a second party; and
the second party transfers the fuel filler cap to the third party verifier without the first party handling the fuel filler cap.

30. The method of claim 28, wherein:
a plurality of fuel filler caps that fail are transferred to the third party verifier; and
verification data from the third party verifier is adjusted to account for resetting of defective vents in the plurality of fuel filler caps during the step of transferring.

31. The method of claim 7, wherein the step of testing comprises a step of removing the fuel filler cap from a respective fuel filler neck and testing the fuel filler cap for leakage with an external test instrument.

32. The method of claim 31, wherein the fuel filler cap is a gas cap, and the test instrument is certified for testing gas caps.

33. The method of claim 32, wherein the test instrument is a hand held gas cap leakage tester.

34. The method of claim 7, wherein the fuel filler cap is installed on a fuel filler neck of a vehicle, and the step of testing comprises a step of using an on-board diagnostic system of the vehicle to test the vehicle's fuel storage system.

35. The method of claim 34, wherein the on-board diagnostic system transfers diagnostic data to an external system, and wherein the step of obtaining emissions offset credits comprises a step of accessing the diagnostic data from the external system.

36. The method of claim 34, further comprising a step of replacing the fuel filler cap with a replacement fuel filler cap while testing the vehicle's fuel storage system.

37. The method of claim 36, wherein the replacement fuel filler cap is a zero leak fuel filler cap.

38. The method of claim 7, further comprising:
determining whether each fuel filler cap is correctly installed on a respective fuel filler neck; and
when the fuel filler cap is not correctly installed,
performing a remedial action selected from the group consisting of providing a user instructions for properly installing the fuel filler cap, and providing the user a tool to aid the user in properly installing the fuel filler cap, and
obtaining emissions offset credits for emissions reductions resulting from the remedial action.

39. The method of claim 38, wherein the tool is a wrench.

40. The method of claim 38, wherein the step of determining whether each fuel filler cap is correctly installed includes visually inspecting the fuel filler cap's installation.

41. The method of claim 38, wherein the step of determining whether each fuel filler cap is correctly installed includes physically checking the fuel filler cap's installation.

42. The method of claim 7, further comprising informing a community member having a fuel filler cap with a leakage between zero and the threshold amount that the fuel filler cap is leaking.

43. The method of claim 42, further comprising obtaining emissions offset credits for emissions reductions resulting from replacing the leaking fuel filler cap when the community member decides to replace the leaking fuel filler cap.

44. The method of claim 7, further comprising:
determining whether each fuel filler cap is compatible with a respective fuel filler neck; and
when the fuel filler cap is not compatible with its respective fuel filler neck,
replacing the fuel filler cap, and
obtaining emissions offset credits for emissions reductions resulting from replacing the fuel filler cap.

45. The method of claim 7, wherein the step of replacing the fuel filler cap comprises replacing the fuel filler cap with a touchless fuel filler cap.

46. A method for obtaining emissions offset credits by testing a population of fuel tanks that includes instances of missing fuel filler caps, comprising:
checking whether each fuel filler neck of the population of fuel tanks has a missing fuel filler cap; and
when the fuel filler neck has a missing fuel filler cap:
providing a replacement fuel filler cap, and
obtaining emissions offset credits for emissions reductions resulting from replacing the missing fuel filler cap.

47. The method of claim 46, wherein the step of providing a replacement fuel filler cap comprises providing a zero leak replacement fuel filler cap having a lifetime warranty.

48. The method of claim 46, wherein the step of providing a replacement fuel filler cap comprises providing an economic incentive for a community member to provide the replacement fuel filler cap.

49. The method of claim 46, wherein:
the step of obtaining is performed by a first party; and
the steps of checking and providing are performed by a second party.

50. A method for obtaining carbon offset credits, comprising:
testing the integrity of a gas cap on a vehicle that is not subject to having its gas cap tested on a periodic basis;
determining that the integrity of the gas cap is acceptable when the gas cap's leakage is below a threshold;
determining that the integrity of the gas cap is unacceptable when the gas cap's leakage is above the threshold;
replacing the gas cap when its integrity is unacceptable; and
obtaining a carbon offset credit when the gas cap is replaced.

51. A method for obtaining emissions offset credits by reducing use of motor oil, comprising:
upon a request to change motor oil of an engine, testing a condition of the motor oil;
determining whether the condition is acceptable;
changing the motor oil solely when the condition is unacceptable; and
when the condition is acceptable, obtaining emissions offset credits for emissions reductions resulting from not changing the motor oil.

52. The method of claim 51, wherein the step of changing the motor oil comprises a step of using compressed air to remove oil from the engine that would not drain from the engine under the force of gravity, and further comprising a step of obtaining emissions offset credits for emissions reductions resulting from reducing contamination of replacement oil by removing oil from the engine that would not drain from the engine under the force of gravity.

53. The method of claim 51, wherein the step of changing the motor oil comprises a step of replacing the motor oil with reconditioned motor oil, and further comprising obtaining emissions offset credits for emissions reductions resulting from replacing the motor oil with reconditioned motor oil instead of new motor oil.

54. The method of claim 51, wherein:
the step of obtaining is performed by a first party; and
the steps of testing, determining, and changing are performed by a second party for the first party.

55. A method for obtaining emissions offset credits by reducing use of antifreeze, comprising:
upon a request to change coolant in an engine cooling system, testing a condition of the coolant;
determining whether the condition is acceptable;
changing the coolant solely when the condition is unacceptable; and
when the condition is acceptable, obtaining emissions offset credits for emissions reductions resulting from not changing the coolant.

56. The method of claim 55, wherein the step of changing the coolant comprises a step of using compressed air to remove coolant from the cooling system that would not drain from the cooling system under the force of gravity, and further comprising a step of obtaining emissions offset credits for emissions reductions resulting from reducing contamination of replacement coolant by removing coolant from the cooling system that would not drain from the cooling system under the force of gravity.

57. The method of claim 55, wherein the step of changing the coolant comprises a step of cleaning the cooling system.

58. The method of claim 57, wherein the step of changing the coolant comprises a step of filtering the coolant to remove particles to facilitate recycling of the coolant.

59. The method of claim 55, wherein the step of changing the coolant comprises a step of replacing the coolant with coolant including reconditioned antifreeze, and further comprising a step of obtaining emissions offset credits for an emissions reduction resulting from replacing the coolant with reconditioned antifreeze instead of new antifreeze.

60. The method of claim 55, wherein:
the step of obtaining is performed by a first party; and
the steps of testing, determining, and changing are performed by a second party for the first party.

61. A method for obtaining emissions offset credits by reducing evaporation of fuel from a portable fuel container, comprising:
replacing a leak prone portable fuel container with a low leak portable fuel container; and
obtaining emissions offset credits for emissions reductions resulting from preventing evaporation of fuel from the leak prone portable fuel container.

62. The method of claim 61, wherein the portable fuel container is a fuel can.

63. The method of claim 61, wherein the step of replacing comprises offering an owner of the leak prone portable fuel container an economic incentive to obtain the low leak portable fuel container.

64. The method of claim 61, wherein:
the step of obtaining is performed by a first party; and
the step of replacing is performed by a second party for the first party.

65. A method for obtaining emissions offset credits, comprising:
repairing an engine emissions control system; and
obtaining emissions offset credits for emissions reductions resulting from repairing the emissions control system.

66. The method of claim 65, wherein:
the step of obtaining is performed by a first party; and
the step of repairing is performed by a second party for the first party.

67. A method for obtaining emissions offset credits, comprising:
installing an electronic catalytic converter in series with a fuel intake line of an internal combustion engine; and
obtaining emissions offset credits for emissions reductions resulting from installing the electronic catalytic converter.

68. The method of claim 67, wherein:
the step of obtaining is performed by a first party; and
the step of installing is performed by a second party for the first party.

69. A method for obtaining emissions offset credits, comprising:
performing an activity selected from the group consisting of implementing an energy conservation measure and installing a renewable energy source; and
obtaining emissions offset credits for emissions reductions resulting from performing the activity.

70. The method of claim 69, wherein:
the step of obtaining is performed by a first party; and
the step of performing is performed by a second party for the first party.

71. An interface system for gathering emissions reduction data and for converting the emissions reduction data into emissions trading data, comprising:
at least one tester for generating the emissions reduction data;
at least one local computer for gathering the emissions reduction data from the at least one tester; and
a central computer for converting the emissions reduction data gathered by the at least one local computer into the emissions trading data.

72. The system of claim 71, wherein the central computer is configured and arranged to consolidate the emissions reduction data gathered by the at least one local computer.

73. The system of claim 71, wherein the at least one tester comprises fuel filler cap test equipment, and the emissions reduction data includes fuel filler cap integrity data.

74. The system of claim 73, wherein the fuel filler cap test equipment is communicatively coupled to the at least one local computer.

75. The system of claim 73, wherein the at least one local computer is communicatively coupled to the central computer.

76. The system of claim 73, wherein the emissions trading data comprises a credit exchange report.

77. The system of claim 73, wherein the at least one local computer is configured and arranged to automatically obtain the emissions reduction data from the at least one tester.

78. The system of claim 73, wherein the central computer is configured and arranged to allow remote access to the emissions reduction data.

79. The system of claim 73, wherein the at least one local computer is configured and arranged to include voice recognition capability enabling the at least one local computer to record emissions reduction data spoken by a human.

80. A computer readable medium on which is stored a computer program for obtaining emissions offset credits by testing a population of fuel tanks that includes instances of both leaking and non-leaking fuel filler caps, the computer program comprising instructions, which, when executed by a computer, perform the steps of:
testing each fuel filler cap for leakage;
determining that the fuel filler cap passes when the fuel filler cap's leakage is below a threshold amount;
determining that the fuel filler cap fails when the fuel filler cap's leakage is above the threshold amount; and
when the fuel filler cap fails, obtaining emissions offset credits for emissions reductions resulting from replacing the fuel filler cap.

81. A method for obtaining emissions offset credits by replacing a leaking fuel filler cap of a vehicle, comprising:
testing the fuel filler cap for leakage;
replacing the fuel filler cap with a replacement fuel filler cap;
calculating a difference in leakage between the fuel filler cap and the replacement fuel filler cap;
estimating an emissions reduction of the vehicle based on the difference in leakage; and
applying for emissions offset credits for the emissions reduction.

82. The method of claim 81, wherein the step of estimating is further based on at least one of location of the vehicle, fuel efficiency of the vehicle, age of the vehicle, make of the vehicle, size of a fuel tank of the vehicle, and weather at a location of the vehicle.
